(19) United States
(12) Patent Application Publication
(10) Pub. No.: US 2025/0384309 A1
(43) Pub. Date: Dec. 18, 2025

(54) SYSTEMS AND METHODS FOR KNOWLEDGE GRAPH DATA STRUCTURE BASED MACHINE LEARNING

(71) Applicant: ROYAL BANK OF CANADA, Toronto (CA)

(72) Inventors: Chai K. LAM, Toronto (CA); Andriy KOURINNYI, Toronto (CA); Mizanur RAHMAN, Toronto (CA); Chelsea JUKES, Toronto (CA); Xuong Hue TRAN, Toronto (CA); Kenneth BOWMAN, Toronto (CA)

(21) Appl. No.: 19/239,628

(22) Filed: Jun. 16, 2025

Related U.S. Application Data
(60) Provisional application No. 63/660,304, filed on Jun. 14, 2024.

(51) Int. Cl. G06N 5/022; G06F 40/295; G06F 40/58; G06Q 40/08

(52) U.S. Cl. CPC G06N 5/022; G06F 40/295; G06F 40/58; G06Q 40/084

(57) ABSTRACT

A system and method for knowledge graph data structure based machine learning capable of processing claim documents to reduce cycle time and improve client experience and return to work outcomes is proposed. The system uses a Large Language Model (LLM), having a name entity recognition model and next best action engine, to identify claim specific data. The claim specific data may include keywords and phrases which are related to a user's claim or history. A pre-trained knowledge graph data structure trained based on a corpus of similar historical treatments is provided to the next best action engine in combination with the user's information for operating in inference mode. The nest best action engine contains triggers which correspond to the identified entities or relationships, and automatically generates an output data structure.

### CROSS-REFERENCE

This application is a non-provisional of, and claims all benefit, including priority, to: U.S. Application No. 63/660,304 filed on Jun. 14, 2024, entitled “Systems and Methods for Knowledge Graph Data Structure Based Machine Learning”. The related application is incorporated herein by reference in its entirety.

### FIELD

Embodiments of the present disclosure relate to computer architectures for machine learning, and more specifically, embodiments relate to devices, systems and methods that utilize specialized graph data structures in conjunction with machine learning computing architectures.

### INTRODUCTION

A challenge in the insurance industry is the ability to efficiently process structured and unstructured text documents e.g. PDFs, Word with handwritten text (e.g. PDFs, Word documents) for insurance claims such that there is a short cycle time for claim approval decisions and claimants can receive a quick response with personalized recommendations for health services to their claim application.

It can currently take more than 30 days for a Claims Specialist to adjudicate a claim. A lengthy claims processing duration can lead to large balance sheet reserves, which causes ineffective use of capital and impact to net income. In addition, by providing the right recommendation and access to health services, we can reduce the duration of the recovery period, leading to a net benefit to the client, lower claim costs and a reduction in the reserves.

To meet the short cycle time, some claims are approved without prejudice which can lead to unrecoverable costs if the claim is later declined. This challenge is especially relevant as the volume and complexity of claims increase every year, which requires more staff and dedicated expertise/resources to be spent on processing the claims. Increased employee workload and complexity can also negatively affect staff job satisfaction and attrition, leading to a deficiency in the employee workforce and poor customer satisfaction.

Foreign-language claims, such as French language claims, can be particularly challenging as they may need to be translated before processing, lengthening the cycle time by weeks, which can be inefficient and lead to delayed intervention and access to treatment for the claimant.

The inefficiency, resource costs and inaccuracy present in the current claim processing approach provides an opportunity for improvement which will positively impact both the claimants and insurance specialists.

A technical problem that persists is that the handwritten text can have poor structure or entirely lack structure. The lack of structure, along with a high volume of documentation, leads to an extremely high level of computational complexity required for explicit rule-based computing.

### SUMMARY

Specialized graph data structures operating in conjunction with machine learning computing architectures are proposed in various embodiments described herein. A set of knowledge graph data structures are instantiated, populated, and updated over a period of time based on training datasets. As described here, there are different variations of knowledge graph data structures that are maintained, and these can include knowledge graph data structures that are generated on a personalized basis for specific individuals, as well as knowledge graph data structures that are generated for different “persona” clusters.

These knowledge graph data structures are utilized as additional signal inputs into machine learning based next best action engines to generate specific output datasets indicative of potential next actions based on the specific circumstances of an individual. A training phase can be conducted to first identify clusters of similar treatment patterns and outcomes based on tracked data for the treatment of one or more individuals. Once the clusters are identified, a number of “persona” clusters can be generated by iteratively building knowledge graph data structures for each of the “persona” clusters. In some embodiments, the “persona” clusters are nested based on an amount of available information, and classification may also include a signal based on the amount of available information.

For example, there may be persona clusters based on available information that are used for initial triage when there is little information available (e.g., when the claim is first opened, or when an individual first attends a medical facility). However, there may be additional personas that are used for bifurcation and more in depth classification once more information becomes available (e.g., the individual has notes from radiology scans, blood work, urinalysis). In some embodiments, an approach that is used to determine how many and how to automatically generate and separate individual clusters can include proxy measurements for treatment complexity such as cost or recovery time, or a weighted loss function based on a combination of both.

In a variant embodiment, the training approach and cluster generation approach is periodically invoked by the classification machine learning model to re-generate or update persona classifications, clusters, and each persona knowledge graph. This re-training can be conducted so that the system is able to automatically adjust to or handle changes in treatment outcomes, recommended treatment pathways, among others, without explicit programming. For example, a new gene therapy treatment may become available for a particular hereditary disease with vastly improved treatment outcomes, with a new treatment cost and duration. As patients are shifted to these treatments, their records will reflect these treatments and their associated costs, durations, success rates, impacts on downstream activities, etc., and these can be automatically adjusted for through re-training or re-generation of the knowledge graphs from time to time. The re-training can include an intentional recency bias to add additional training weight to more recent training examples to further encourage the automatic updating.

During inference operation, when a new individual's data is being ingested into the system, for example, in the form of input datasets extracted from doctor's notes, hospital APIs, insurance records, etc., a persona classification machine learning model used for identifying the persona clusters can be used to first classify and categorize the individual in respect of highest similarity to a specific generated persona cluster. Named entity recognition engines can be used to pre-process ingested data to assist in improving the accuracy of the classifications and datasets during inference operation.

The corresponding trained knowledge graph can then be used to generate a set of logit/probability outputs based on a potential identified next course of treatment for the individual. This process can also be used iteratively to build out second order treatment, third order treatment, among others, and an output data structure indicative of the individual's next action, second next action following each of the potential first next actions, etc., can be populated. This data structure can include logit probabilities for each, and ultimately be used to generate a tree of potential outcomes and treatment paths for the individual that is personalized based on a combination of the categorized knowledge graph, as well as the individual's characteristics.

As new information and datasets become available in respect of a particular individual, the machine learning model for identifying the next course of treatment can be re-run based on the updated information to identify changes to the output data structure that need to be updated. In some embodiments, as new information and datasets become available, the persona classification machine learning model may also be re-run to re-classify the user (e.g., automatically shifting selected persona knowledge graphs to a more similar knowledge graph). For example, the user may first present with arm pain from an accident and a bone appears to be broken. Then, the user may input details of the accident (e.g., fell from tree) that are captured during intake.

As the user provides more details or testing results become available through radiology, electronic health records, among others, an improved dataset of the user's condition is now available. This can include co-morbidity information or characteristics (osteoarthritis, diabetes, age, severe hypertension, infection, sepsis) that will have impacts on whether treatment will be successful, as well as a potential duration of recovery and required rehabilitation. Similarly, additional information may include radiology outputs that are captured such as whether the user has an open fracture, a compound fracture, a stick fracture, etc.

As the new information is captured, the classification model can be operated in an inference mode to determine whether the user needs to be classified in respect of a different persona. When the next best action model is operated on inference to establish generated set of logit/probability outputs, it can thus attempt to utilize the knowledge graph as an input of the most similar persona. A technical benefit of using only a limited number of possible persona clusters is that it allows the computation to be operated with a practically manageable amount of computational power, as every iteration of updates and training can be computationally expensive in view of finite computing processing resource and time.

The output data structure generated by the next best action machine learning model operating in inference, once fully populated, can be used for various practical downstream uses. Example downstream uses include automatically recommending or requisitioning courses of treatment for an individual, or generating probabilistic treatment plans or identifying a predicted total treatment cost, which can then be used from an insurance perspective to right-size an allocation based on a complexity level associated with a particular individual's characteristics, presented injury, as well as the specific trained knowledge graph for a particular persona. The output data structure can be provided across a programming interface to a visualization engine to control the rendering of visual interface elements on a coupled user interface, such as a user interface on a user or a claim advisor's personalized computing device, such as a personal computer, a terminal, or a smartphone. These visual interface elements can include a probabilistic map of the user's treatment, along with expected costs, duration, and a probability of successful treatment for different treatment options, as well as second and third-level analyses depending on different treatment paths.

As described herein, the system is a technical approach for utilizing machine learning and generative AI large language models (LLMs) that are configured for processing structured and unstructured documents with handwritten text and identifying key healthcare and demographic related details and terms from the text to populate the knowledge graphs described herein that are used as input signals when generating computerized estimate values corresponding to recommended next best actions. Handwritten text images can be processed using optical character recognition (OCR) and large language model technology to establish datasets and the approach is not limited to unstructured handwritten text and insurance claims, and can include digital forms, computerized notes, and health adjacent industries.

In particular, the approach involves a computational process that converts documents containing handwritten text to a digitized format before being fed into an artificial intelligence computer program to extract important details and data that can then be used to populate a knowledge graph for determination of an optimal next best action.

A system for machine learning processing of handwritten text images and producing recommended next steps is thus proposed that utilizes optical character recognition (OCR) technology to convert the handwritten text images in Portable Document Format (PDF) or Word documents to machine readable text with output in JavaScript Object Notation (JSON™) format. As described herein, the OCR technology can use LLMs that are trained to recognize entities and relationships between entities. Such entities and relationships may be pre-defined in a knowledge graph and included in a prompt to the LLM using advanced prompting techniques such as predefined and chain of thought templates to optimize results. For example, such entities can include key words and phrases such as demographic data, dates, symptoms, medical conditions, medical diagnosis, medications and treatments. As the individual undergoes treatment, treatment related datasets can be monitored and collated, and used periodically to update the specific persona-based knowledge graph data structure. Accordingly, the accuracy of the knowledge graph and corresponding traversals can be updated based on actual treatment results.

The digitized text output from the OCR can then be added to the prompt to the Large Language Model (LLM) for named entity recognition to categorise and identify key words and phrases in the unstructured text documents that are relevant to determining next best actions. For example, such key words and phrases can include details related to patient demographics, procedure codes, diagnosis codes, and billing information. In some embodiments, the LLM optimized for named entity recognition will be trained in disability insurance claims terminology and historical data. For example, such training data can include symptoms, medication, recovery period and so on.

The output from the LLM can then be used to query the knowledge graph with the identified entities in the document. The knowledge graph connections can be analyzed by a recommendation system to produce optimal next best actions, based on identified patterns and historical data within the knowledge graph. This system can be used, for example, but not limited to, processing large amounts of insurance claims from various claimants to produce personalized recommendations for each claimant as to what their best next steps should be in their insurance case. In other examples, documents can include an attending physician statement (APS), medical reports, and other medical documents.

In some embodiments, the recommendation system can sort a batch of claim files by priority for claims processing based on files most likely to be closed first and send the prioritized claims to the claims adjudicator by role as determined by the area of specialty. By way of example, claim priority may be established in part on the estimated recovery period determined from the historical claim patterns. An employee trained in disability claims can be (but not necessarily) included in the process to review the recommendation given by the system for the next best action and decide on next steps. The system will then monitor the results of the recommendations and any acceptance or rejection action taken by the Claim Specialist and augment the knowledge graph on a continuous basis using the results data collected for a claimant(s). With key entities, relationships and Next Best Actions captured in the knowledge graph, the LLM can analyze historical claims data, policy information, and demographic factors to identify trends, patterns, and potential risks. The LLM may assist in predicting claim outcomes, estimating costs, and suggesting strategies for effective claims management and underwriting. In addition, by providing the right recommendation and timely access to health services, the duration of the claimant's recovery period can be reduced, leading to a net benefit to the client, lower claim costs and a reduction in the reserves.

As described herein, specific technical approaches are also proposed that include specifically configured machine learning architectures and data structure configurations to manage and limit a computational complexity of the training and inference operation of the machine learning models, while maintaining a sufficiently high computing feature resolution to generate useful predictive results. The number and complexity of knowledge graph data structures that are maintained and used for next best action analysis and generation can be constrained to a set of representative personas. As described in variant embodiments, the set of representative personas can also be managed using unsupervised learning and cluster analysis such that representative personas can be automatically bifurcated or merged as actual treatment prognoses and outcome information is used to retrain the system. Accordingly, the system can be configured to attempt to automatically adjust to retraining information by modifying the computational approach while respecting complexity limitations in the overall maximum number of possible persona knowledge graphs being maintained at a particular time.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an architecture diagram of a proposed system for improved claim processing, according to some embodiments.

FIG. 2 is a process diagram containing steps taken by a proposed system for improved claim processing, according to some embodiments.

FIG. 3 is an example of potential claim documents and recognized key words and phrases identified by the named entity recognition engine, according to some embodiments.

FIG. 4 is an example knowledge graph showing key words and phrases as entities which each contain relationships to other entities for assisting in providing next best action recommendations, according to some embodiments.

FIG. 5 is a data flow process diagram for operation of a proposed system, according to some embodiments.

FIG. 6 is a flow chart process diagram for operation of a proposed system populating a knowledge graph with inputted entities and relationships, according to some embodiments.

FIG. 7 is a flow chart process diagram for operation of a proposed system responding to a prompt from a user to query a populated graph, according to some embodiments.

FIG. 8 is a flow chart process diagram for operation of a proposed system searching for terms based on a prompt from a user and providing a response to the user based on retrieval results, according to some embodiments.

FIG. 9 is a user interface for a claim specialist, with a display of the next best action recommendations and other relevant information, produced by a proposed system, according to some embodiments.

FIG. 10 is an architecture diagram of a proposed system for training the large language model for improved claim processing, according to some embodiments.

FIG. 11 is a schematic diagram of a computing device such as a server, according to some embodiments.

FIG. 12 is a process diagram showing steps of an example method for using persona-based knowledge graphs, according to some embodiments.

FIG. 13 is an example set of knowledge graphs for different personas, according to some embodiments.

### DETAILED DESCRIPTION

Specialized graph data structures operating in conjunction with machine learning computing architectures are proposed, which is adapted to using knowledge graph data structures. A technical challenge with using machine learning computational architectures is that there are finite computing resources and processing time available, especially given the number of possible feature dimensions in complex data sets. As described herein, a number of different variations are proposed that limit the overall computational complexity for practical implementation by identifying a limited number of persona classification clusters during inference operation.

The system is practically implemented as a computer system implemented as a computer server or a set of coupled distributed computing resources that is configured to ingest electronic inputs in the form of received datasets. These electronic inputs can include claim documents that are electronically processed to have relevant information extracted using optical character recognition technology. The system includes programming modules that are operated both to train and update machine learning engines and their underlying interconnections, nodes, weights, and parameter values, as well as to update and maintain a set of knowledge graph data structures that are used as inputs into the machine learning engines during inference operation. The system can be a special purpose machine that operates in a data center that is coupled to messaging buses that include API interconnections to receive and process document data sets in real or near-real time, and can be coupled to the message bus to output data structures based on machine learning predictions that are used for predictive next best actions, structured based on different options that are possible, as well as possible probabilistic permutations of treatment outcomes.

The generated outputs can be used for controlling interfaces to render visualizations, or to generate reports or recommendations that are ultimately used to reduce cycle time and improve client experience, and in a non-limiting example use case for insurance claims, assist in improving return to work outcomes with improved accuracy in machine learning based predictions for evaluating and suggesting treatment options automatically.

For data inputs, the system first uses a Large Language Model (LLM) to identify claim specific data which correspond to a recommendation system. The claim specific data may include keywords and phrases which are related to a user's claim or history. The claim specific data can be pre-processed and stored in a knowledge graph data structure as either an individual entity, or as a relationship/hierarchy of entities, which are ingested by the recommendation system. The recommendation system contains triggers which correspond to the identified entities or relationships, and may provide a user with an output report which can be used to prioritize and efficiently handle written claims.

A non-limiting practical use case for the proposed system and method is utilizing the system and its corresponding artificial intelligence (AI) and/or neural network (NN) architecture to efficiently process, organize, store and link data objects corresponding to contextual data of an insurance claimant, and prioritize insurance claim decision making. Insurance documentation often includes unstructured handwritten text images, making it difficult to efficiently store and link inter-related data collected over a claimant's entire journey through the insurance system. According to the proposed system, these unstructured documents are first converted into a digitized format.

Once in the digitized format (i.e., PDF or Word document), the digitized document is organized as tokenized and encoded data, such as JSON text files. The encoded data is then provided to a large language model (LLM) in a prompt for identification, classification and determination of key word and phrase entities that may exists in the digitized document. The identified key word and phrase entities are fed into a knowledge graph, as an intermediate output, representing the next best action model.

The knowledge graph is used to generate downstream outputs, such as recommendations, prioritizing or batching claims for adjudication. As described herein, proposed variations utilizing limited sets of cluster-based analysis for persona classification and usage are contemplated to assist in reducing the overall computational complexity while maintaining sufficient predictive accuracy tailored to the specific characteristics presented for an individual. By using the persona cluster-based knowledge graph that is trained and updated periodically based on a corpus of actual treatment outcomes as an additional input into the machine learning model for generation of output logits representative of potential next best actions, the system exhibits improved output accuracy.

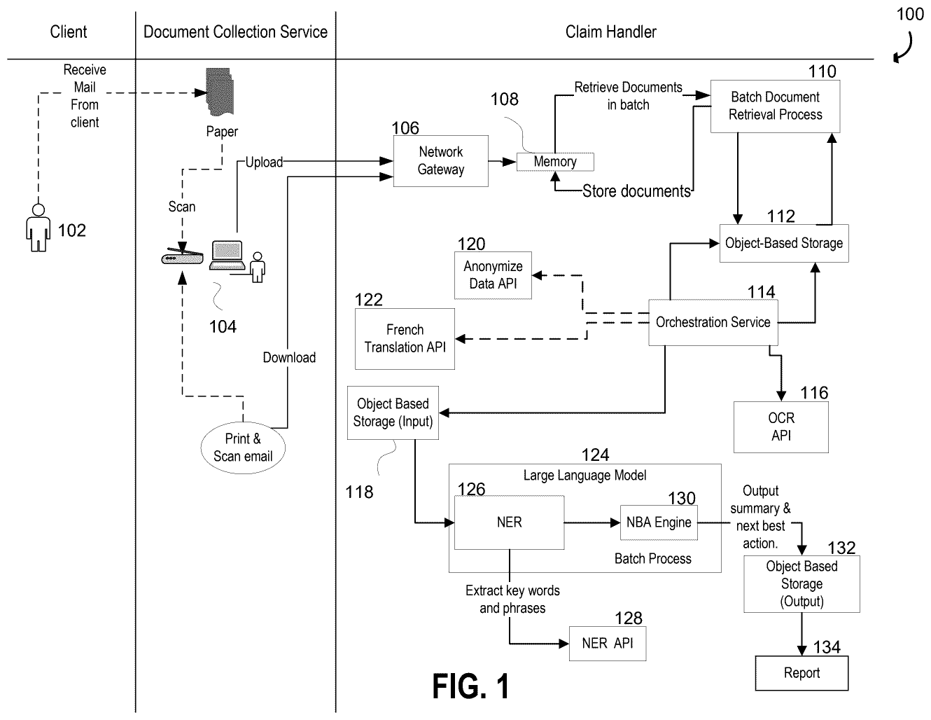

FIG. 1 is an architecture diagram of an example system, according to some embodiments.

The proposed system 100 operates within an environment which is integrated into the standard system of claim processing. The proposed system 100 is designed to handle unstructured documents such as doctor's notes, hospital records, client forms, pharmacy records, Disability Claim Specialist's notes, the attending physician statement and the like. To begin the claim adjudication process, the client 102 will submit an unstructured document to a collection service which receives the claim and prepares it to be sent to the claim adjudicator. Due to at least a portion of the unstructured documents typically being handwritten, the collection service may scan 104 the handwritten document and store the unstructured document as a PDF or comparable document, and then transfer the scanned document to the claim handler. The scanned document may be received by the claim handler on a universal network gateway 106 for receiving submitted documents, which may be configured to receive claims submitted online, through a third party, or in-person submission. The network 106 may be in real time or near real time communication with the proposed system 100 such that upon the network 106 receiving a batch of scanned documents, the network 106 will send the scanned documents to the proposed system through a memory storage device 108.

The proposed system 100 is configured to retrieve the scanned documents in batches from the memory device 108 through a batch retrieval process 110 which is in two way communication with the memory device 108 such that the batch retrieval process 110 may be configured to retrieve documents for initiating the process of the proposed system 100, and outputs from the proposed system 100 may be stored within the memory device 106. When the batch retrieval process 110 retrieves scanned documents from the memory device 106, the scanned documents are provided to an object-based storage medium 112, such as Amazon S3™ or a comparable object based storage medium. The batch retrieval process 110 appends distinct unit identifiers to the scanned documents and is configured to store the identified scanned documents in the object based storage medium 112. The object based storage medium 112 is configured to receive the large input of unstructured scanned documents such that the scanned documents can be stored as batches which can be accessed using the identifiers when called upon.

The orchestration service 114 is configured to pull batches of documents from the objected based storage 112 using a get command. The orchestration service 114 is configured to serve as a central control which oversees and has authority over the flow of data within the proposed system 100. The orchestration service 114 is configured to send out the batches of documents to primary and secondary APIs located within the system. The primary APIs may include an optical character recognition (OCR) API 116 and an input object based storage medium 118. The secondary APIs may include a French translation API 122 and a data anonymization API 120. The primary and secondary APIs receive batches of scanned documents and, upon performing a specified action, return the batches of scanned documents to the orchestration service 114.

The orchestration service 114 first sends the batch of scanned documents to the OCR API 116. The OCR API 226 may be an OCR Engine which is used to convert the unstructured scanned documents from scanned text images in PDF or Word format, to machine readable JSON text files. In some embodiments, the OCR API 116 may be a third party tool which is embedded within the system.

Upon providing the scanned documents in JSON text files back to the orchestration service 114, the orchestration service 114 may be configured to transfer the JSON text files to the data anonymization API 120 or French translation API 122 (secondary APIs) if required. In some embodiments, the French translation API 122 is configured to process a specific list of French medical terms that require unique translations into English (comprehensive list of terms and phrases that need one-to-one handling). In another variant embodiment, the system is designed to translate terms based on the context provided, ensuring as much accuracy as possible.

For example, doctor's notes or other documents containing sensitive health information may be provided to the data anonymization API 120, and documents from clients located in Quebec or who have selected French as their language of correspondence will be sent to the French translation API 122. In some embodiments, the data anonymization API 120 may anonymize and encrypt JSON text files containing sensitive information. In some embodiments, to further ensure protection of sensitive information, the LLM 124 and memory device 106 may be deployed on-premise instead of in public based cloud storage. In some embodiments, the French translation API 122 may include third-party licensed software (including SaaS solutions) that have been vetted and approved to handle sensitive information and data.

In some embodiments, the French translation API 122 may be a purpose-built translation engine stored within a local on-premise server which is configured to receive text strings and perform translation within a medical or insurance context. For example, text strings within an insurance document may include unique medical terms/phrases, or terms of art unique to a patient-medical professional relationship, which require a contextual approach to translation in order to provide accurate translated text strings for further named entity recognition. Standard “off the shelf” translation software may be ill suited for this type of translation as the translations may strip certain terms of important context which will impact downstream named entity recognition and recommendation accuracy. In some embodiments, the French translation API 122 contains a purpose-built library of French medical terms and phrases which are translated to corresponding English terms and phrases. In some embodiments, the library may be updated based on terms and phrases which are identified by the LLM 124 in French language claim documents that do not have a corresponding English translation in the library, and which are flagged by either the LLM 124 or a claim specialist as potentially being a medical term or phrase requiring specific translation.

Further, by implementing French translation API 122 as a purpose-built translation engine within an on-premise server, an increased level of data security may be achieved which is desirable when handling potentially medically sensitive information related to a claimant's insurance file. Translation software which requires cloud storage and/or access may compromise or reduce data security due to increased threat-vectors being introduced within the overarching system.

After either the OCR API 116 or, if the secondary APIs are required, the Data anonymization API 120 and/or French translation API 122, have returned the batch of documents to the orchestration service 114, the batch JSON text files are sent to the input object based storage medium 118 where the JSON text files are stored in batches. The LLM 124 may be configured to request batches of JSON text files from the input object based storage medium 118 for processing.

The LLM 124 receives the JSON text files and is pre-trained for Named Entity Recognition (NER) 126, specifically, a NER API 128 may be used to scan for key words and phrases which are then identified and stored as entities in the NER 126 within the LLM 124. The key words or phrases are stored as tokenized strings within the LLM 124. For example, a key word or phrase may include text related to dates, symptoms, medical conditions, diagnosis, medications and/or treatments.

The NER API 128 may utilize retrieval augmented generation frameworks and prompt techniques to retrieve key words and phrases. The NER API 128 extracts not just the key words and phrases, but may also extract the context in which the key word or phrase was used. The combination of the key word(s) or phrase(s) and the context is stored as an entity. Within the system 100, entities stored within the knowledge graph are treated as themes which can be used to define a claimant based on, for example, patient demographics, procedure codes, diagnosis codes, treatment results and billing information, and the corresponding connections between these entities. The ability to store entities containing key words or phrases and context makes it possible, at a later stage, to create relationships between one or more entities and to create personas to further augment the NER API 128 and LLM 124 outputs. Once the NER API 128 has finished scanning the batch of documents for key words and phrases, the NER 126 within the LLM 124 will provide the identified entities to a next best action (NBA) engine 130.

In some embodiments, the NER 126 may be augmented through in-context learning, where the NER API 128 may receive from the NER 126 expected key words and phrases in each document type (i.e., doctor's notes, hospital records, client forms, pharmacy records, Disability Claim Specialist's notes, the attending physician statement, etc.) in the context of an LLM prompt. In-context learning may improve the accuracy of the final LLM 124 output without the need for extensive fine-tuning of the model, especially when a large quantity of key words and phrases have been identified as pre-defined entities for identification and extraction from the documents for driving the NBA recommendation(s).

For example, a sub-set of recognized and expected document types may be pre-identified to contain expected key words, phrases and relations. For each document type, a pre-defined set of key words, phrases, and themes (i.e., keywords/phrases+context) are stored in the knowledge graph which are used by the NER 126 to refine and augment the recognition of key words/phrases and context within the specific document type. The document type is identified and assigned a meta data tag when it is ingested in the Content Management Repository. The pre-defined set of key words, phrases and themes may be based on expected strings or data objects that drive downstream next best action recommendations by the NBA engine 130.

In some embodiments, the pre-defined set of key words, phrases and themes may be further refined as more data objects and connections are stored for a specific claimant, allowing the pre-defined set of key words, phrases and themes to be tailored to specific claimant personas based on expected outcomes or NBA recommendations. By continuously adding to the identified key words, phrases and themes associated with document types, the knowledge graph structure for a claimant may be augmented to include further themes and personas. As further data objects are incorporated into a claimant's knowledge graph, the LLM 124 will have more entities to search through when generating a next best action recommendation, and the persona associated with a claimant, based on their knowledge graph, can be identified with further levels of granularity.

In some embodiments, the pre-defined set of key words, phrases and themes may be further refined as the LLM 124 identifies further relationships/connections between data objects identified by the NER 126 and downstream outcomes of the NBA engine 130 recommendations.

The NBA engine 130 inputs the identified entities into a knowledge graph which captures the entities and relationships that drive the NBA engine 130. The entities are then mapped to the next best steps using a model which outputs one or more NBA recommendation(s) to an output object-based storage medium 132. The entities and relationships within the knowledge graph act as triggers for the NBA engine 130, such that certain NBA recommendations may be triggered based on the presence of a finite number of entities present in the knowledge graph. For example, an NBA recommendation may be triggered by one entity being present in the knowledge graph or by two or more entities being present in the knowledge graph. In another example, the NBA recommendation may be based on identified patterns and historical data within the knowledge graph. In another example, the same entity may be a trigger for multiple NBA recommendations. In another example, the NBA engine 130 may output an NBA recommendation with a confidence score, when some but not all of the entities attached to an NBA recommendation are present. In a further example, the NBA engine 130 may rank the NBA recommendations based on the confidence score.

In some embodiments, the NER 126 may be augmented using both the knowledge graph and the LLM 124 to identify key words and phrases in the unstructured documents. In a further embodiment, once an action has been taken on an NBA recommendation, the knowledge graph may be updated to show that an NBA recommendation corresponding to one or more entities was resolved, that treatment is in progress, or the result of the proposed treatment.

In some embodiments, the NBA engine 130 may initially populate the knowledge graph with entities and relationships identified in response to prompts input into the LLM 124 by a user. For example, a prompt may be input into the LLM 124 requesting whether a patient requires a specific form of treatment (i.e., whether an NBA recommendation should be made for a specific form of treatment). The LLM 124, through the NER 126, may then identify and store in the knowledge graph (i.e., populate the knowledge graph) any entities or relationships within the patients documents which correspond to the prompt. Once sufficient entities and relationships have been input into the knowledge graph, the knowledge graph may be tested and reviewed, including through human intervention or feedback, by comparing a ground truth NBA recommendation (i.e., an expected result or previous outcome of an NBA recommendation) against the expected entities and relationships within the knowledge graph that would trigger the NBA recommendation.

The knowledge graph may be augmented based on the outcome of the testing in order to adjust the entities and relationships that correspond to an outputted NBA recommendation. The augmented knowledge graph may be more accurate due to the previous NBA recommendation outcomes or patient history being input into the knowledge graph as entities that map to previously identified entities and relationships. The augmented knowledge graph may be used by the NER 126 and NBA engine 130 to refine the entities and relationships that are identified in the patient's documents and the resulting NBA recommendations that are outputted by the NBA engine 130. This may enable the NBA engine 130 to continuously improve over time.

Preferably, each claimant persona can have a unique set of nodes and edges in the knowledge graph which is stored as a separate and distinct structure. However, in some embodiments, the knowledge graphs of two or more claimant personas may be linked based on overlapping entities or relationships which exist across the two or more claimants.

The knowledge graph structure enables each claimant's history and unique data objects to be stored as a set of nodes, attributes and edges which can be used to identify overlapping patterns across knowledge graphs of multiple claimants. Personas can be generated within the LLM 124 which are stored as a pre-defined set of entities and relationships based on specific outcomes and NBA recommendations associated with the persona.

Personas act as pre-identified profiles of a hypothetical claimant, and each persona has a unique knowledge graph stored within the LLM 124 which contains nodes defining entities related to demographic data, occupational data and the like, which are connected to nodes defining health and historical data such as health conditions, previous and current treatments/referrals (including previous next best action recommendations), possible future next best action recommendations, and outcomes of previous treatments. The nodes and edges within the knowledge graph of a persona form a profile which provides visibility into expected outcomes and recommendations for claimants who have knowledge graphs with a degree of overlap with one or more personas. The LLM 124 may utilize personas to determine a ranking or confidence score for a next best action recommendation based on overlap with existing personas, and the associated expected outcome associated with a persona.

Personas may drive the output of the NBA engine 130 by acting as a repository of possible treatment pathways for claimants based on their unique knowledge graphs. The NBA engine 130 may be configured to search a claimant's knowledge graph for patterns of entities and relationships which overlap with existing personas.

According to one principle of operation of the NBA engine 130, the claimant's knowledge graph is compared to a persona knowledge graph which has been identified as having a pattern of overlapping entities and relationships. The NBA engine 130 may identify, based on the contextual metadata included within each entity in the claimant's knowledge graph, where along the recovery pathway the claimant is currently at. As each persona knowledge graph may map out an entire recovery pathway, from initial diagnosis to recovery, the claimant will be temporally placed within the recovery pathway defined by the persona knowledge graph.

For example, NBA engine 130 may identify that a claimant has just received surgery, and therefore the next best action recommendation will be generated based on identifying the set of nodes and edges which lead to a positive treatment outcome. As a claimant's journey through the recovery pathway is not always linear, relapse or unexpected outcomes are an inevitable aspect of treatment. As these outcomes can be accounted for within the claimant's knowledge graph through treatment outcome entities having connections to entities representing the previously recommended next best action, the LLM 124 may continuously revise the alignment of a claimant with one or more personas to account for more complex cases which require more intensive or extended treatment.

In some embodiments, a claimant can be aligned with two or more personas which are aligned with a claimant based on a confidence score. This may occur when the knowledge graph of the claimant has contains partial, but not complete, overlap with a set of two or more personas, and therefore the NBA engine 130 may generate next best action recommendations associated with some or all of the set of two or more personas. When a claimant is aligned with two or more personas, the next best action recommendations may include a confidence score based on a degree of overlap the claimant has with each persona which was used to generate the respective next best action recommendation.

Personas may be used to identify outlier knowledge graphs based on claimants who match a certain persona but have certain knowledge graph entities or relationships that would not be expected for a specific persona. This may assist with identifying potential fraud. This may also augment the NBA engine 130 and NER 126 by generating further sub-personas based on identifying common “outlier” entities and relationships within a knowledge graph for claimants who do not match pre-defined persona.

As net new or sub-personas are generated within the LLM 124, the NBA recommendations associated with a persona may become more targeted as the underlying entities and relationships for each persona become more granular.

In some embodiments, the LLM 124 may be configured to continuously or periodically compare the existing personas against one or more claimant knowledge graphs to spawn new personas.

The LLM 124 may be triggered to generate a new persona once a threshold cluster of current and historical claimant knowledge graphs show a matching divergence from an existing persona. For example, Claimant A, who is currently undergoing treatment for a work related MCL tear, has a knowledge graph which is associated with Persona X. Persona X defines an expected recovery pathway and timeline for a 35 yr old male with an MCL tear, who works in the trades, has no known underlying health conditions and is a smoker. It would be understood that the above data is by way of example only, and further entities and relationships can make up a persona. The next best action recommendation is for Claimant A to be scheduled for surgical repair of the MCL tear. According to Persona X, the expected pathway for Claimant A after completion of the surgery is to begin basic rehabilitation and physiotherapy 4-6 months post-op and to be clear of any further health complications from the MCL tear at 10-12 months post-op. Therefore, the expected next best action recommendation after LLM 124 receives a digitized document that confirms completion of the MCL surgery is for Claimant A to begin rehab 4-6 months post-op, and the knowledge graph of Claimant A may have an entity (i.e. node) representing the expected treatment outcome and timeline based on the knowledge graph for Persona X. The entity representing the expected treatment outcome and timeline would be connected (through an edge(s)) to the treatment entity in Claimant A's knowledge graph representing the treatment (i.e., MCL surgery) to form a relationship within the knowledge graph. Further, the entity representing the expected treatment outcome may be connected through edges within Claimant A's knowledge graph to further entities representing demographic, health or personal data which have been identified as impacting the treatment outcome and timeline for an MCL tear.

Continuing the example above, once Claimant A receives the MCL surgery and a digitized document is retrieved by LLM 124 confirming completion of the surgery, the NBA engine 130 may be prompted to retrieve and generate a next best action recommendation based on the knowledge of Claimant A. As mentioned above, due to Claimant A being associated with Persona X, the next best action recommendation with the highest confidence score may be rehab 4-6 months post-op, and this output will be displayed to a Claim Specialist on a user interface through a portal. The claim specialist will be presented with the next best action recommendation and have the option to accept, reject or modify the next best action recommendation. Assuming the claim specialist approves the next best action recommendation, Claimant A will proceed with receiving rehab once they are 4-6 months post-op.

Due to Claimant A being associated with Persona X, not only can the NBA engine 130 be prompted to determine a next best action recommendation based on the associated persona, but an expected timeline and recovery pathway can also be generated for the claim specialist based on the knowledge graph of Persona X.

As mentioned above, personas comprise knowledge graphs which are representative of one or more themes (i.e., relationships between entities) that a claimant can be associated with. Personas may not be an isolated knowledge graph representing a point in time, but instead can represent an entire recovery pathway beginning at, for example, initial diagnosis, and ending at full recovery (or in the case of chronic health issues, at healthy management of pain or issues). Therefore, the LLM 124 may be configured to compare a claimant's knowledge graph with a knowledge graph of a persona, and identify what point along the recovery pathway the claimant is currently at. For example, using the scenario above, Claimant A who has just been diagnosed with an MCL tear, may be associated with Persona X based on the existing entities (nodes) and themes (nodes+edges) present in Claimant A's knowledge graph, but Persona X contains future state entities and themes which have not yet been identified and stored within the knowledge graph of Claimant A.

Due to the persona knowledge graphs including entities and themes representing the expected future state of the claimant's knowledge graph, timelines and expected next best action recommendations can be reviewed by a Claim Specialist before they have become formally identified in a digitized document within the broader claim processing system. This technical benefit of using a knowledge graph structure in combination with LLM 124 may permit a Claim Specialist to have deeper and more accurate insights into a claimant's entire file, and reduce the uncertainty and size of resource and monetary reserves due to increased clarity into future state budget and workload expectations.

As LLM 124, using NER 126, extracts a growing number of entities from digitized documents (belonging to the plurality of claimants) which are input into the system 100 at gateway 106, further relationships will be generated within the plurality of knowledge graphs stored within the LLM 124. As the depth and complexity of the knowledge graph structures within system 100 increases, representing a growing set of entities and connections being formed, the LLM 124 may begin bifurcating or merging personas based on the resulting treatment and recovery outcomes which are being identified by NER 126.

Returning to the example of Claimant A, if the next best action recommendation of receiving rehab 4-6 months post-op is approved by the Claim Specialist, the progress and recovery timeline for Claimant A can be estimated based on the knowledge graph of Persona X. As Claimant A works their way through the rehab process, further digitized claim documents may be retrieved by the LLM 124 as they are uploaded at gateway 106 which document the progress of Claimant A as they work towards recovery. As NER 126 extracts the keywords, phrases and context from the digitized documents, the knowledge graph of Claimant A will be expanded to include entities and themes correlating to the treatment outcomes and timelines of Claimant A provided by their physiotherapist. For example, Claimant A's knowledge graph may be updated with recovery outcomes stored as entities which identify that Claimant A has regained weight bearing strength, has regained full joint motion, has begun walking and has been cleared of any further physical limitations (i.e., full recovery). These recovery outcomes are connected, through edges, to the next best action recommendation(s) present within the knowledge graph, such as the initial decision that Claimant A begin therapy 4-6 months post-op. Due to the entities within the knowledge graph of Claimant A including not just keywords and phrases, but also context such as timeframes, the recovery outcomes (i.e., positive or negative outcomes form treatment) and the timeframe of the recovery can be compared to the expected outcomes and timeframes present in the knowledge graph of Persona X.

LLM 124 may identify that Claimant A had a longer recovery timeframe or a negative outcome associated with a treatment, and this divergence from the expected outcome and/or timeframe in Persona A may flagged by LLM 124. In some embodiments, LLM 124 may be configured to flag a divergence between a claimant and an associated persona as potential fraud, for example, when an expected recovery timeframe for a persona diverges from the actual recovery timeframe for a claimant who is recovering from a workplace injury, as this may be evidence that the claimant is intentionally delaying a return to work.

In some embodiments, a flag for potential fraud identified by the LLM 124 may be output by report 134, such as through a server, which alerts a Claim Specialist of the flag and displays on a graphical user interface the details which resulted in the flag.

In some embodiments, LLM 124 may identify divergence between a claimant's knowledge graph and the expected outcomes or timeframes of an associated persona, and generate a new persona based on an identified pattern of divergence across a plurality of claimants. For example, LLM 124 may identify a subset of claimants who were initially associated with a persona but had a divergence from the expected results. This divergence could include an unexpected treatment outcome or a recovery timeframe which is shorter or longer than expected. LLM 124 may be configured, either through prompts or autonomously, to collect and sort the identified divergences and map the users based on their originally assigned personas and entities within their knowledge graph which resulted in the divergence. Upon LLM 124 identifying a cluster of claimants which have overlap relating to their originally assigned personas and the entities which resulted in their divergence, a new persona may be generated to capture the pattern of divergence. The new persona may be generated through LLM 124 searching the knowledge graphs of the subset of diverging claimants for overlapping structural differences with the knowledge graph structure of the originally assigned persona.

These overlapping structural differences may include the presence within the subset of claimants' knowledge graphs of one or more entities or relationships which are not present within the knowledge graph of the originally assigned persona. The overlapping structural differences may also include entities or relationships which are missing within the subset of claimant knowledge graphs, but which are present within the originally assigned knowledge graph. Therefore, the overlapping structural differences relate to a divergence pattern, identified by the LLM 124 through advanced searching, of nodes and edges within the subset of claimants which may have a causal relationship with the unexpected treatment outcome or timeframe experienced by the subset of claimants.

The knowledge graph of the new persona may be a bifurcation of the originally assigned persona, in which the new persona and originally assigned persona would have a similar structure, except that the new persona would be structured to capture the divergence pattern identified in the subset of claimants, such that the new persona provides a more tailored and accurate prediction of the knowledge graphs of the subset of claimants.

If a cluster of other users have similar outcomes, the LLM 124 may be augmented by comparing the cluster of other claimants to identify a pattern, resulting in a new persona, Persona Y, being generated to more accurately tailor the expected outcomes and timeframes to the patterns being seen within the cluster of other claimants.

Returning to the example above involving Claimant A, LLM 124 may identify that Claimant A has begun rehab 4-6 months post-op, but has been referred to a specialist due to increased inflammation and minimal mobility being present in the knee that was operated on. This treatment outcome diverges from the expected treatment outcome of Persona X, which Claimant A was initially aligned with. LLM 124 may map Claimant A to a cluster of other claimants that were initially aligned with Personal X, but their respective knowledge graphs also contained a similar divergence. LLM 124 may be configured to perform advanced searching within the cluster of knowledge graphs and identify that a subset within the cluster all include an entity, which has a timestamp predating the MCL tear, relating to a diagnosis of varicose veins. As the knowledge graph of Persona X does not include an entity relating to the diagnosis of varicose veins, this entity has no relationship with the resulting treatment recommendation (next best action recommendation) that may be generated by NBA engine 130 for claimants aligned with Persona X. However, as LLM 124 has identified this pattern of divergence, a new persona (Persona Y) may be generated by LLM 124 which has a knowledge graph structure which captures claimants diagnosed with an MCL tear who have a pre-existing diagnosis of varicose veins. Persona Y may be automatically generated or can be reviewed by a “human in the loop” before becoming operational within LLM 124. A human may review Persona Y and recognize that varicose veins would adversely impact lower body blood circulation, resulting in a reduced rate of recovery for MCL tear surgeries, and accordingly accepting the proposed new Persona Y. The knowledge graph structure of Persona Y may diverge from that of Persona X's by recommending both rehab 4-6 months post-op, and also a medical procedure to reduce or eliminate the varicose veins. Therefore, if a claimant is aligned with Persona Y, the NBA engine 130 will generate a next best action recommendation which accounts for the nodal relationship that has been identified by LLM 124 between MCL tear recovery and varicose veins.

In some embodiments, LLM 124 may be configured to identify convergence across the knowledge graph structures of two or more claimant groups associated with two or more personas and merge the personas into a single persona, thereby reducing redundancy and improving the storage efficiency of the system 100. For example, as a result of a new treatment/procedure becoming standard for a certain diagnosis, LLM 124 may identify that the treatment outcome for two or more sets of claimants belonging to two or more personas have begun to converge, while under the previous treatment/procedure the treatment outcomes for the same two or more sets of claimants contrasted sufficiently to justify two or more personas.

The terms divergence and convergence as used to describe the similarity and differences between a claimant's knowledge graph and a persona knowledge graph may be expressed within the LLM 124 as a rules-based metric which may, for example, be expressed as a percentile when considering expected treatment timeframes (i.e., +/−20% of 20 months), or as a string/entity based rule when considering treatment outcomes (i.e., “increased mobility” vs. “reduced mobility”).

Another technical benefit of structuring the entities and relationships for a specific claimant within a knowledge graph is that extensive search capabilities can be performed at a system, claimant and document level. Further, since entities may be stored with object notation denoting the corresponding document ID, date and context under which they were retrieved, time boxing may be performed to further refine the NER 126.

For example, due to the nature of insurance claim handling, documents relating to a claimant may be received by system 100 over the course of months, years or in some cases, decades. This may be due to ongoing or chronic health conditions which require varying degrees of treatment as a patient moves along the health continuum. As the structure of the knowledge graph is comprised of a web of entities (i.e., key words, phrases and context) which are interconnected to form relationships/themes, and since each entity may comprise a data object having a timestamp denoting when the entity was identified by the LLM 124, searching within the LLM 124 can provide both current and historical knowledge graphs from a claimant.

Compared to traditional searching techniques, without the technical benefit of the knowledge graph structure, the LLM 124 may generate results beyond just an individual entity that was present at a specific timeframe in a claimants file (i.e., searching for past medical procedures). Instead, the LLM 124 is configured to leverage the knowledge graph structure to provide time-boxed search results for both individual entities and the entire knowledge graph structure, including themes, personas and next best action recommendations, for a claimant between a specified time-frame. This may generate a clear and more accurate picture of a claimant's journey along the health continuum. Instead of time-boxing, in an alternate embodiment, the system can be configured to show the history of recommendations and the actions taken (recommendation accepted/rejected) and reasons. This assists the claims specialist in deciding on the next best action to be taken. Positive outcomes could also update the history and personas in the knowledge graph.

The extensive searching enabled though the knowledge graph structure may be used to perform system wide searching which identifies knowledge graphs, and their associated claimants, who may be impacted by certain regulatory or pharmaceutical changes.

For example, if pharmaceutical X has been recommended to no longer be used for individuals with high blood pressure, claimants who have active prescriptions (identified through entities stored within their knowledge graphs) may be warned of this to provide them with time to find an alternative. Further, staying within the same example, knowledge graphs may be searched to identify certain claimants who have a set of entities/relationships which put them at a higher risk for high blood pressure, and the NBA engine 130 may restrict prescribing pharmaceutical X as an output for the identified claimants.

The knowledge graph structure, specifically the node and edge structure enabled by the data object format of the entities identified by the NER 126, provide a technical benefit of point in time analysis of a claimant's data. As the knowledge graph for a claimant is filled out with further information, deeper insights are possible which may be both forward and backward looking.

For example, a claimant undergoing treatment may receive multiple next best action recommendations throughout their period of recovery. The claimant may be associated with a matching persona which can be used to generate an expected path to recovery. The matching persona would comprise a knowledge graph structure which has an overlapping node and edge structure with the claimant's knowledge graph, signifying that the claimant and persona have matching entities and inter-entity relationships within their knowledge graphs. The knowledge graph associated with the matching persona may have future-state iterations, which signify the possible, and expected, recovery pathways of the persona. By leveraging the matching persona's knowledge graphs, both present and future-state iterations, an expected recovery period can be determined for a specific claimant resulting in improved claim handling and more efficient resource management.

By way of another non-limiting example, the knowledge graph structure can be used to create future-state documents which are expected to be received for a specific claimant. The future-state document may be compared to actual documents which are received and processed by the system at a later date, and the LLM 124 may identify the overlap and differences between the entities present in the future-state document v. the actual document. Based on the results from the comparison, the LLM 124 may be configured to refine the entities associated with an NBA recommendation for the claimant and/or trigger a follow-on NBA recommendation.

A further benefit of the knowledge graph structure incorporated into the proposed system and method is that as further entities and relationships are generated, the entities and relationships associated with NBA recommendations may be further refined based on identifying common outcomes of NBA recommendations associated with knowledge graphs having overlapping entities and relationships.

For example, certain entities which are identified and stored by the NER 126 within the claimant's knowledge graph may initially have no impact on the NBA recommendation generated for a claimant. However, a system wide view of the totality of knowledge graphs may identify that a specific outcome, such as a negative response to a treatment, is present for claimants who share one or more entities/relationships which were initially thought to be tangential. The LLM 124 may augment the NER 126 and NBA engine 130 to identify future claimants who have these entities/relationships present in their knowledge graphs, and adjust the NBA recommendation to account for the expected outcome.

This is possible due to the structure of the knowledge graph, as a claimant level view, as opposed to a document by document level view, is provided which includes both historical and future state insight into the claimant's journey through the healthcare system.

The NBA recommendations may be stored on the output object based storage medium 132, which is communicatively coupled to a reporting engine 134. The reporting engine 134 may be configured to access the NBA recommendations and provide a summary and output report to the claim specialists who can then accept or reject the recommendation(s).

In one embodiment, the NBA recommendations may include review for closure, review for referral to drug compatibility program, review for referral to medical confidence program, review for mental health service provider (e.g. Medaca™) referral, review for rehab referral, review for insurance investigative services referral and the like.

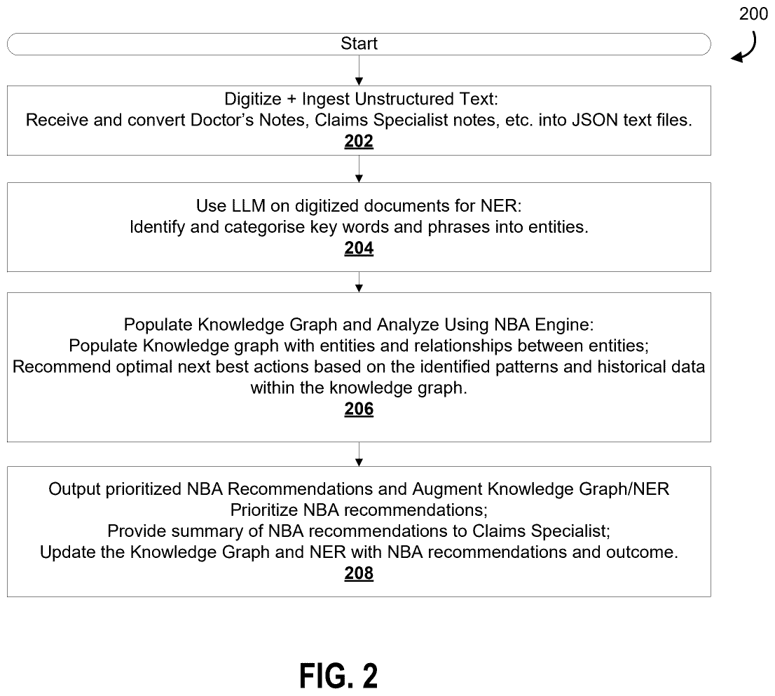

FIG. 2 shows a process diagram containing method steps taken by a proposed system for improved claim processing, according to some embodiments. The process 200 receives as an input unstructured documents and provides as an output a list of prioritized NBA recommendations which can be acted upon by a claim specialist. The LLM 124 and NER 126 may be continuously retrained using the outputted NBA recommendations and claim specialist actions.

These method steps are shown as examples for one embodiment and variations are possible including different sequences of the method steps discussed below.

Process 200 is initiated at 202 when the proposed system receives unstructured documents which are digitized into JSON text files by the OCR API 116. The JSON text files are stored as batches of digitized documents which are ingested by the LLM 124. At 204, the LLM 124 uses a NER API 128 to identify and categorize key words and phrases into entities. Entities are composed of the identified key words or phrases and the context in which the key words or phrases were used.

The NER 126 within the LLM 124 may be trained to identify keywords and phrases using training data which provides a set of NBA recommendations and identified key words and phrases, and then having the NER 126 work backwards to determine the key words and phrases that were identified to cause the NBA recommendation to be outputted.

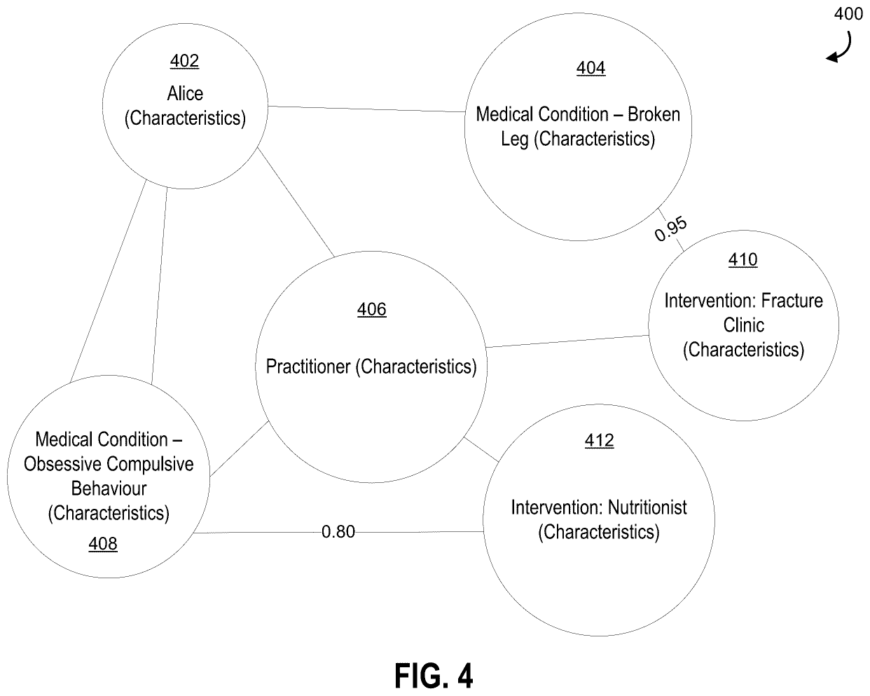

At 206, the LLM 124 populates a knowledge graph with the identified entities from the NER 126. The knowledge graph will then be analyzed by the NBA engine 130 to determine NBA recommendations. In some embodiments, the knowledge graph is first populated with the identified entities, and then connections are made between two or more entities to represent relationships. This will be discussed further in FIG. 4. In some embodiments, the NBA engine 130 will analyze the knowledge graph to identify patterns and historical data to provide NBA recommendations.

The NBA engine 130 may be a rules based engine which contains a listing of potential NBA recommendations and the corresponding criteria for outputting the NBA recommendation to a user. In some embodiments, NBA recommendations are determined based on the presence, or omission, of sets of entities within the knowledge graph. For example, NBA recommendation A may be outputted by the NBA engine 130 when entities X and Y are present, NBA recommendation B may be outputted when entity Z is present, NBA recommendation C may be outputted when entities X and Z are present, and NBA recommendation D may be outputted when entity X is present and entity Y is not present. As can be seen, each NBA recommendation may be composed of a unique set of one or more entities, including entities which overlap with other NBA recommendations.

At 208, the NBA engine 130 outputs a prioritized list of NBA recommendations which can be acted upon by a claims specialist through a user interface. Outputted NBA recommendations are also provided back to the LLM 124 for augmenting the knowledge graph and NER 126. In some embodiments, the NBA recommendations are prioritized based on urgency, such as most likely to be closed first, upcoming due dates, monetary amount or medical severity. In some embodiments, the NBA recommendations are prioritized based on a confidence score.

For example, a confidence score may be used when an NBA recommendation needs 5-6 entities to be triggered but only 3-4 have been identified in the claimant's file, this may lead to a lower confidence score being attached to the NBA recommendation. In some embodiments, the confidence scores may be used to rank the NBA recommendations using metrics such as 0.8, 0.3 and 0.1, representing the expected accuracy of the NBA engine 130.

In some embodiments, prior to the prioritized NBA recommendations being generated and acted upon by a Claims Specialist, a Disability Claims Specialist may be capable of interacting with the LLM 124 to review the NBA recommendations and identify faulty recommendations or prioritization decisions made by the NBA engine 130. The LLM 124 may be configured to receive the results of the intervention by the Disability Claims Specialist (i.e. accept/reject certain recommendations) and re-process the prioritized NBA recommendations based on the feedback to further fine tune the generated prioritized NBA recommendations and retrain the models on a continuous basis.

The NBA engine 130 will provide the prioritized NBA recommendations to a Claims Specialist by role as determined by the area of specialty. The prioritized NBA recommendations may be displayed on a user interface which allows the Claims Specialist to promptly respond to the highest priority/urgent NBA recommendations requiring actioning (accept/reject recommendation).

The LLM 124 may be configured to retrieve a batch of claim documents on a daily basis, and correspondingly update the network and knowledge graph, such that a new prioritized claim listing is produced daily. In some embodiments, the prioritized NBA recommendations may be continuously updated as further batches of documents are completed, such that a rolling listing of recommendations are continuously provided to the Claims Specialist.

The LLM 124 may be configured to re-process the outputted prioritized NBA recommendations, resulting actions taken by the Claims Specialist, and outcome of the actioned NBA recommendations, to augment the knowledge graph and NER 126, and therefore allowing for retraining using the updated knowledge graph and intervention results.

For example, the NER 126 or LLM 124 may be retrained based on historical data on a quarterly basis. In some embodiments, the historical data is stored as a relationship within the knowledge graph, for example, the initial NBA recommendation is connected to the action taken by the Claims Specialist, which is then further connected to the outcome of the action, such that a three-way relationship is formed between each entity.

By storing historical NBA recommendations in the knowledge graph, insight and history into what NBA recommendations were taken and why they were taken can be used for training the LLM 124 for a single client or across a grouping of clients.

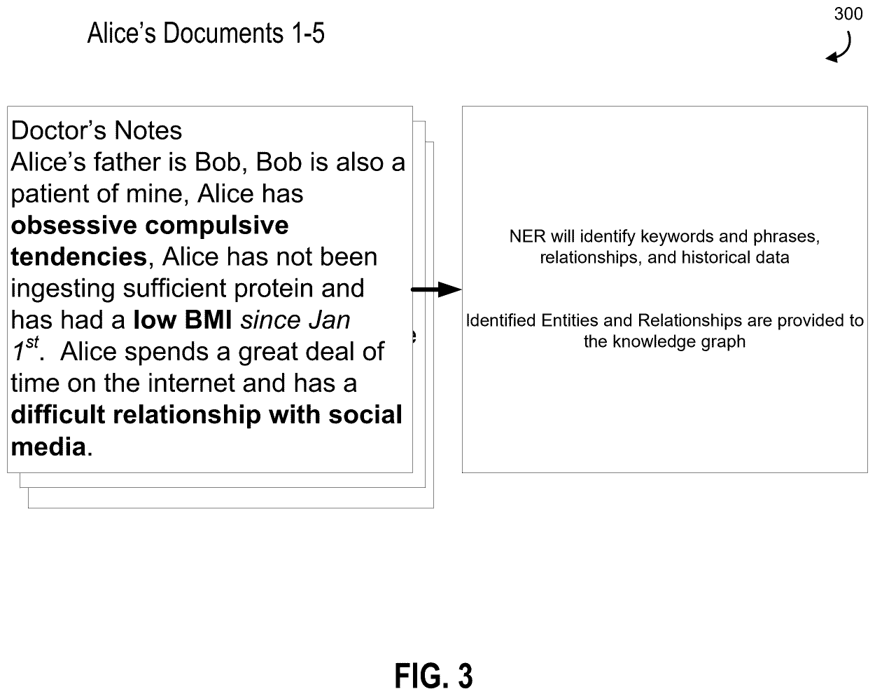

In operation, the following example, using fictious names and details, is provided in FIG. 3 and FIG. 4 to provide context to process 200.

In process 300, Alice, a client of the claim handler, submits 5 documents including a Doctor's note from her attending physician. Alice is raising a mental health claim to the claim handler and has a prior history of submitted claims. Alice's documents are hand written notes which have been digitized to JSON text file using the OCR API 116. The NER API 128 will receive Alice's documents as a collection of string tokens (“Alice's father is Bob, Bob is also a patient of mine . . . ”), which are sorted into batches, wherein each batch and document has a unique identifier (for example, each batch may be identified by client and date, documents within a batch may be identified by string token and client).

The NER API 128 identifies key words and phrases within the string of each digitized document which correspond to an NBA recommendation (i.e. “obsessive compulsive tendencies”, “low BMI”, “difficult relationship with social media”). The identified key words and phrases are then combined with any relevant context (i.e. “since January 1^{st}”) to create entities which are provided to the knowledge graph 400 as an intermediate output.

An example knowledge graph 400 for Alice is shown in FIG. 4, showing key words and phrases as entities which each contain relationships to other entities for assisting in providing next best action recommendations. The example knowledge graph 400 shows an entity 402 for Alice which would contain characteristics including age, occupation, where she lives, and the like. The knowledge graph 400 contains an entity 404 which relates to a previous claim submitted by Alice for a broken leg, and an entity 406 which relates to Alice's attending physician.

Entity 404 may include characteristics such as date of injury, claim status and type of fracture. Entity 406 may include characteristics such as practice location, specialization and the like. Entity 410 relates to a previous intervention recommended by the NBA engine 130 and may include characteristics such as date of recommendation, result of recommendation and follow-up requirements. Entity 408 relates to an entity provided to the knowledge graph 400 based on the entities identified by the NER 126 in the Doctor's Note from FIG. 3. Entity 412 relates to the NBA recommendation provided by the NBA engine 130 based on the entity 408 provided to the knowledge graph 400 due to the Doctor's Note from FIG. 3.

As can be seen in FIG. 4, confidence scores may be provided for relationships between entities, such as a score of 0.8 and 0.95 representing the expected accuracy of the NBA engine 130 in determining the NBA recommendations. In a further embodiment, other NBA recommendations may be included in knowledge graph 400, based on the Doctor's Notes from FIG. 3, which have lower confidence scores, such as pharmaceutical intervention or counselling, but only entity 412 will be provided to the claims specialist due to the high confidence score and urgency (i.e. wait times for nutritionists may be higher than other medical intervention options).

In some embodiments, knowledge graph 400 may be specific to Alice. In another embodiment, knowledge graph 400 may overlap with other clients, for example, clients which have had similar medical conditions or use the same practitioner.

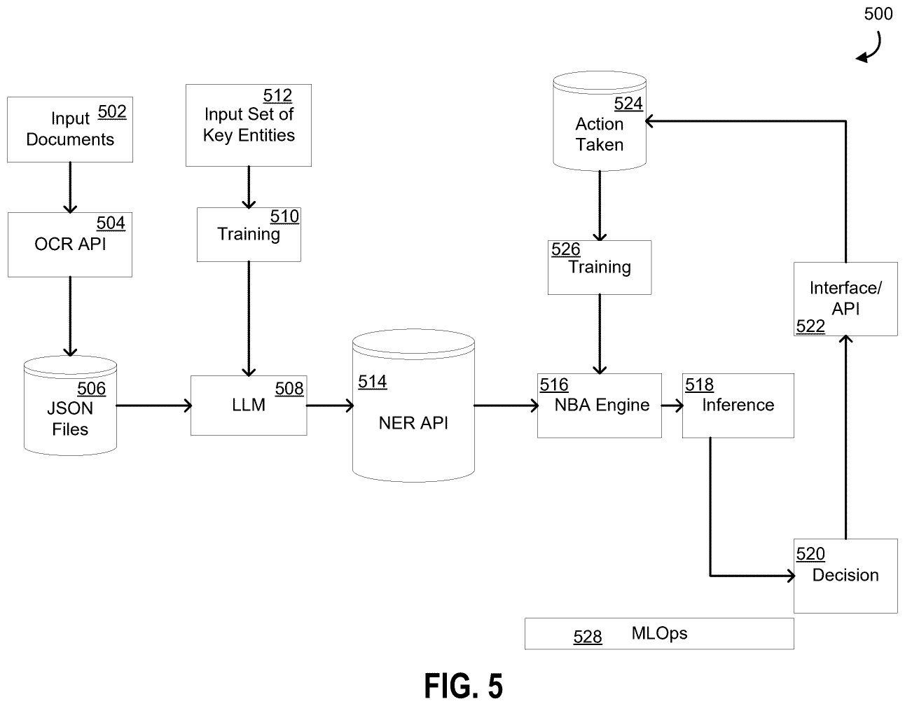

FIG. 5 is a data flow process diagram for operation of a proposed system, according to some embodiments.

The data flow process 500 is initiated when input documents 502 provides scanned unstructured documents to the OCR API 504. OCR API 504 digitizes the unstructured documents into JSON text files which are stored in JSON files 506 as tokenized strings. The tokenized strings are then provided to the LLM 508 in batches. The LLM 508 is trained 510 using training data containing sets of key entities 512 which are used by the LLM 508 to learn the resulting recommendations which occurred as a result of the key entities 512.

In some embodiments, training 510 may include a set of pre-identified NBA recommendations with their associated entities and relationships that drive the pre-identified NBA recommendation. In a further embodiment, training 510 may further provide the LLM 508 with the expected key words and phrases that correspond to specific document types ingested by the OCR API 504.

The LLM 508 uses a NER API 514 to identify key words and phrases which correspond to NBA recommendations. The entities identified by the NER API 514 are provided to the NBA engine 516 through a knowledge graph which contains historical and current entities identified by the NER API 514, and relationships between the identified entities. The NBA engine 516 analyzes the knowledge graph and identifies NBA recommendations based on the entities that are present. The NBA recommendations are provided to inferences 518 which prioritizes and/or ranks the NBA recommendations based on one or more of urgency, confidence score, claim resolution date, monetary amount, and the like. The resulting prioritized NBA recommendation listing is then provided as the final output of the process 500 at decision 520.

Decision 520 may output the prioritized NBA recommendation listing to a user interface 522 which can be accessed by a Claims Specialist and allows the Claims Specialist to review and action the NBA recommendations based on priority. The resulting action which the Claims Specialist determines is the most appropriate based on their review of the claim file is stored in action taken 524. This may include actions such as accept recommendation, reject recommendation, amend recommendation or delay recommendation.

Action taken 524 is used by training 526 to retrain the NBA engine 516, the retraining of the NBA engine 516 will have a carry on impact as the knowledge graph and NER API 514 will be updated based on the NBA engine 516 retraining to reflect the new key entities which correspond to the augmented NBA recommendations.

In some embodiments, an MLOps platform 528 may be present within the LLM 508 which provides continuous support, incidence management, training, deployment and monitoring of the LLM 508. The MLOps platform 528 is configured to track the triggers and intermediate outputs of the NBA engine 516. The MLOps platform 528 may be configured to be an external network which can be controlled by a user through a terminal. The MLOps platform 528 may be configured to compare the triggers which lead to inference 518 (intermediate outputs) being generated by the NBA engine 516 against the action taken 524 by the claim specialist, and identify inferences which have led to rejections by the claim specialist, and communicate potential adjustments or training data sets to training 526 to fine tune the NBA engine 516.

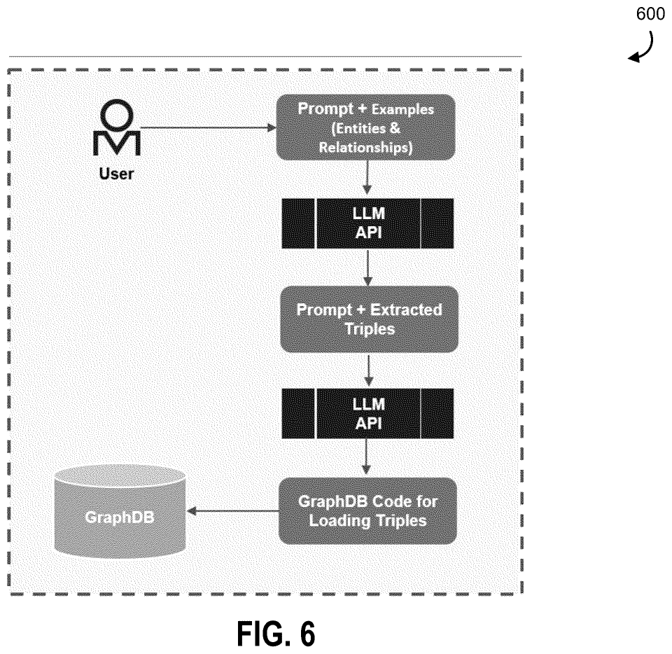

FIG. 6 is a flow chart process diagram of a proposed system populating a knowledge graph with inputted entities and relationships, according to some embodiments.

In the process 600 seen in FIG. 6, a user submits a prompt, which provides context to the LLM API to identify the expected entities in the tokenized JSON text file. The entities and relationships, for example, key words and phrases, context and dates, are extracted and loaded into the knowledge graphDB. The knowledge graphDB is a database which contains the entities and relationships from historical and current claim submissions. The knowledge graphDB stores the knowledge graph for each claimant, where each claimant and the entities within each claimant's knowledge graph has a unique unit identifier which can be accessed by a processor upon a prompt by a user being input into a user interface.

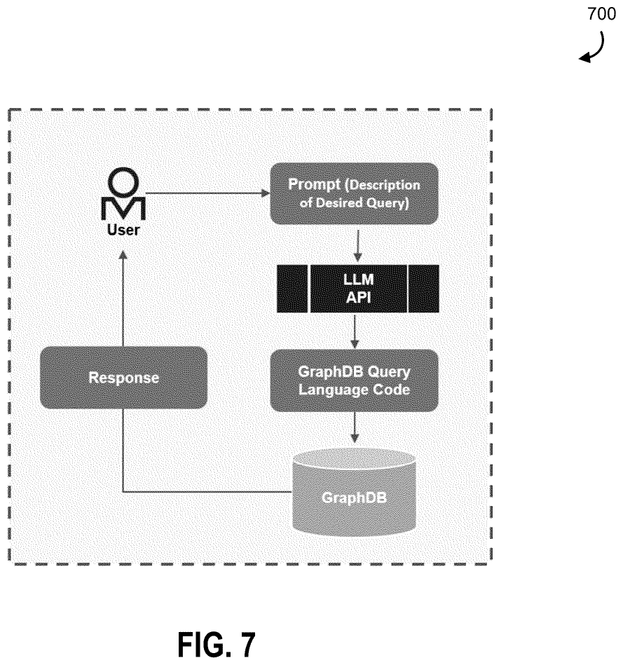

FIG. 7 is a flow chart process diagram of a proposed system responding to a prompt from a user to query a populated graph, according to some embodiments.

In the process 700 seen in FIG. 7, a user provides a prompt to the LLM comprising a desired query for information from the knowledge graph. The LLM converts the desired query into language code which can be parsed by a processor and a get command can be sent to the knowledge graphDB to provide a response. The LLM may identify key words and phrases within the prompt which will be used to pull the relevant information from the knowledge graphDB. A processor can interoperate with the knowledge graphDB to provide a response to the user based on the information provide to the processor by the LLM. If the user is not satisfied by the response, the user may refine the prompt based on the response and initiate the process again. The LLM may store the outcome for each response provided and refine the query language code provided to the processor and knowledge graphDB to augment the process.

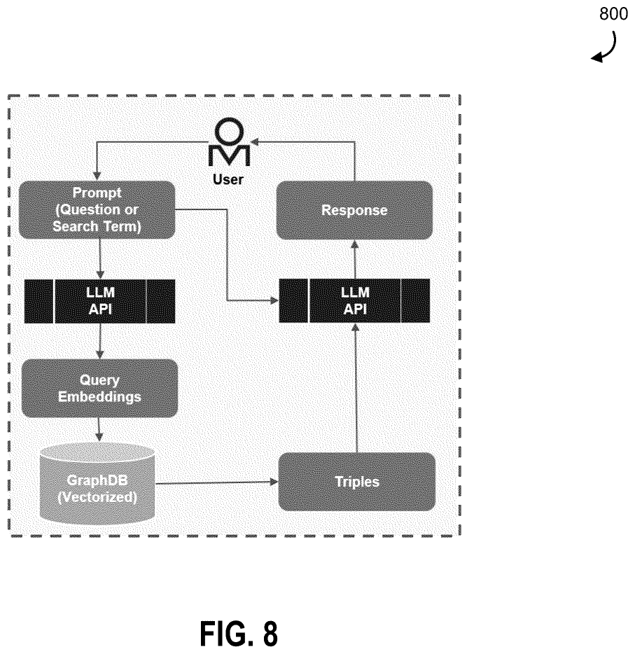

FIG. 8 is a flow chart process diagram for operation of a proposed system searching for terms based on a prompt from a user and providing a response to the user based on retrieval results, according to some embodiments.

In the process 800 seen in FIG. 8, a prompt is generated by the orchestration service 114 and transmitted to the LLM 124 (LLM API), the prompt contains a question(s) or search terms (key words and phrases, including context based on the document type) related to an NBA recommendation. The prompt is predefined and is specific to the document type to instruct the LLM to search for the key words and phrases in the document. The process is run in batch mode by applying the prompts to thousands of documents daily in a batch run.

The LLM API utilizes the prompt to identify key entities and relationships within a patient's documents. The prompt may also be stored within the LLM API for further retraining at a later step. The key entities and relationships identified by the LLM API are converted into a vector which allows the entities and relationships to be stored within the GraphDB as query embeddings, over time the GraphDB will be populated with query embeddings from previous prompts. The query embeddings allow the GraphDB to capture the similarity between the entities and relationships, and can be used to identify context and group the entities and relationships based on their similarity. The LLM API may retrieve from the GraphDB data in the form of triples, the triples being an ordered sequence of vectors representing the entities and relationships which drive the NBA recommendation included in the initial prompt. The LLM API may convert the vectors contained in the triples into a string of entities and relationships which can be outputted as a response to a user. The user may review the accuracy of the GraphDB by comparing the ground truth NBA with the entities and relationships which drive the NBA recommendation. The GraphDB can be augmented based on the results of the user review to adjust the query embeddings which map to one or more NBA recommendations. This process may enable the LLM API to continuously improve over time.

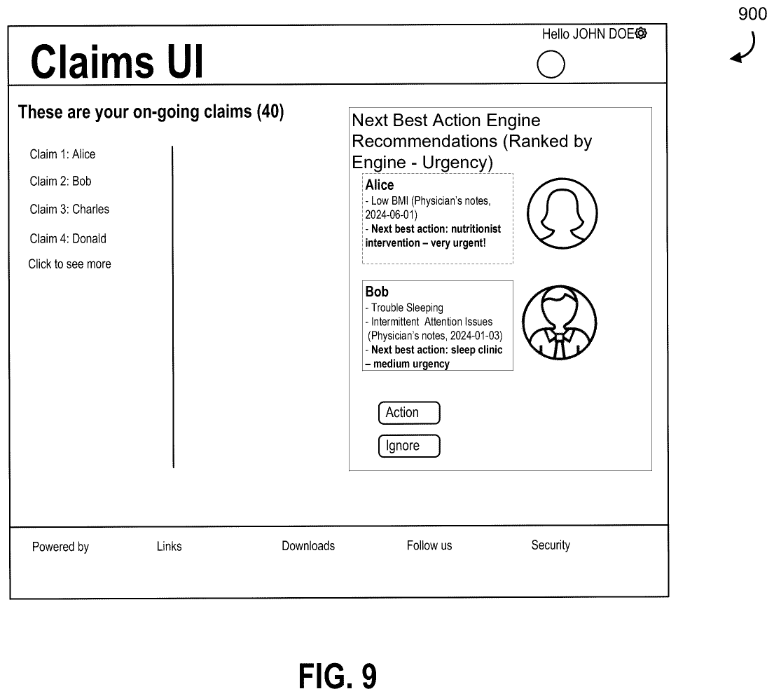

FIG. 9 is a user interface 900 for a Claims Specialist, with a display of the next best action recommendations and other relevant information, produced by a proposed system, according to some embodiments.

User interface 900 is rendered on an interactive display which can receive inputs from a claim specialist through a terminal, user interface 900 may be configured to communicate with a processor which may provide as an input to the user interface 900 the prioritized recommendations from an NBA engine. The user interface 900 contains information provided by the NBA engine 130 relating to the active claims being handled by a Claims Specialist. In some embodiments, the NBA recommendations are displayed in order of priority, with the most urgent recommendations requiring actioning before the next recommendation will be displayed.

The Claims Specialist interacts with the user interface 900 through control of an input device such as a mouse, touch screen or keyboard which is communicatively coupled to a terminal. The Claims Specialist may input a command to the interactive display to select actions based on the recommendation which is being presented by the user interface 900. The Claims Specialist has the option to accept the recommendation or reject the recommendation.

In a further embodiment, the Claims Specialist may have the option to amend or delay the recommendation. The NBA recommendation may be displayed alongside further information such as the key words or phrases which triggered the NBA recommendation, and the urgency or confidence score corresponding to the NBA recommendation.

The actions taken by the Claims Specialist for a specified NBA recommendation may be stored within a knowledge graph for the client to create a record of the client's history. The action taken will be used to augment the NBA engine 130 and NER API 128 to refine the key words and phrases which trigger an NBA recommendation.

The NBA engine 130 and NER API 128 may be augmented, using an action taken by the Claims Specialist, for a specific client, or universally such that an action taken for a specific client will augment the NBA engine 130 and NER API 128 for all future NBA recommendations. In a further embodiment, the outcome (i.e. success, failure, further treatment needed) from an NBA recommendation may be stored within a knowledge graph and provide further data for retraining the NBA engine 130 and NER API 128.

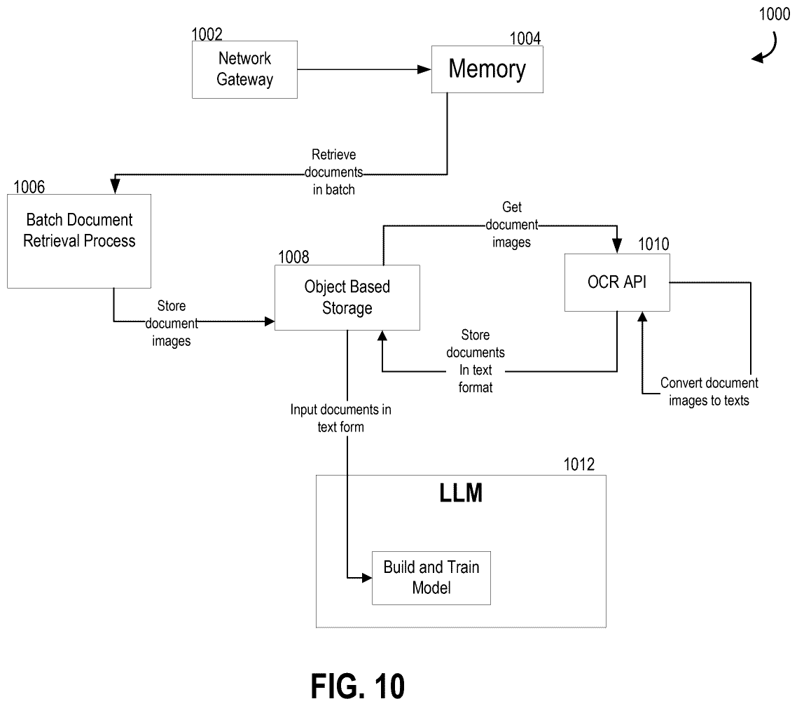

FIG. 10 shows an architecture diagram configured for training of a proposed system containing the large language model for improved claim processing, according to some embodiments.

The training system 1000 is capable of training the LLM 1012 to be optimized for Named Entity Recognition. The system 1000 generates a training set containing Disability Insurance Claims terminology and historical data (e.g. symptoms, medication, recovery period etc.) which may be used to identify key details from medical documents, such as doctor's notes and medical reports. This can include extracting details such as, but not limited to, patient demographics, procedure codes, diagnosis codes, and billing information. In some embodiments, historical data may be provided to the knowledge graph which can continuously improve the NER API 128.

In a further embodiment, after a period of about 6 months, the knowledge graph will have sufficient historical data to begin creating relationships amongst different entities. Historical data may include previous recommendations which were output by the LLM 1012, and the resulting outcome of the recommendation. For example, if a previous recommendation was unsuccessful, the LLM 1012 may re-process the entities in the knowledge graph, including the outcome from the previous recommendation, and determine that a more intensive recommendation is needed. The LLM 1012 may be configured to augment the NER API 128 to identify within unstructured documents key words and phrases which are associated with unsuccessful previous treatment, and update the knowledge graph with entities representing the unsuccessful treatment.

The LLM 1012 may also be continuously trained using historical claims data which are stored within a memory 1004. The historical claims data may include data relating to the outcome of previous recommendations as compared to the outcome taken by the adjudicator.

The LLM 1012 may also be trained using policy information, and demographic factors to identify trends, patterns, and potential risks within a claim. The use of the above mentioned training data will assist in predicting claim outcomes, estimating costs, and suggesting strategies for effective claims management and underwriting.

The training system 1000 comprises a network gateway 1002 and memory 1004 which may operate in the same manner as discussed above in FIG. 1. Batch document retrieval process 1006 may retrieve historical claim data and/or other training data which are received by the batch document retrieval process 1006 as unstructured scanned documents. The unstructured scanned documents are transmitted to, and stored within, the objected based storage 1008 and provided to the OCR API 1010.

The OCR API 1010 digitizes the scanned unstructured documents into a tokenized and encoded format such as a JSON text file. The digitized document is then sent to the LLM 1012 in batches which are used to train and build out the model.

Claims related to mental health conditions which make up for over 30% of claims can require various forms of treatment over the course of the recovery period. This is referred to as the mental health continuum. This often requires multiple next best actions based on the stage of the recovery. The system will track the outputted NBA recommendations in the knowledge graph over the course of the recovery journey to assist the claims specialist in providing the best service to assist the client to access the right services at the right time.

The proposed system and method will reduce claims processing time, leading to a reduction in the amount of time a client is approved (or not) for claim payment. This will also reduce the amount of cash reserves required on the balance sheet to support claims liabilities, and reduction in claims processing expenses and better client and employee experience. In addition, through NBA recommendations, the client may be promptly provided with access to value-added services and programs, getting them access to treatment sooner during the claim period, leading to faster recovery. The proposed system and method may also reduce computing time and infrastructure requirements as the unstructured documents are stored as strings within the system architecture, which can be accessed based on unique identifiers. Further, the proposed system and method may reduce the infrastructure requirements due to the knowledge graph only storing entities, representing key words or phrases, that correspond to a trigger for a NBA recommendation, reducing the storage needs of the system since the remaining document data can be stored on a storage device external to the system.

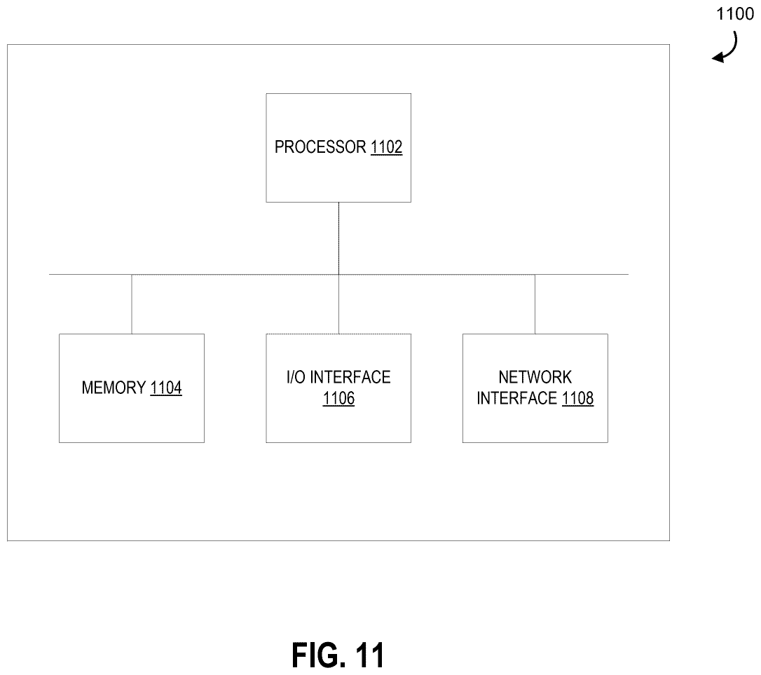

FIG. 11 is a schematic diagram of a computing device 1100 such as a server which may implement the proposed system discussed above. As depicted, the computing device includes at least one processor 1102, memory 1104, at least one I/O interface 1106, and at least one network interface 1108.

Processor 1102 may be an Intel or AMD x86 or x64, PowerPC, ARM processor, or the like. Memory 1104 may include a suitable combination of computer memory that is located either internally or externally such as, for example, random-access memory (RAM), read-only memory (ROM), compact disc read-only memory (CDROM).

Each I/O interface 1106 enables computing device 1100 to interconnect with one or more input devices, such as a keyboard, mouse, camera, touch screen and a microphone, or with one or more output devices such as a display screen and a speaker.

Each network interface 1108 enables computing device 1100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

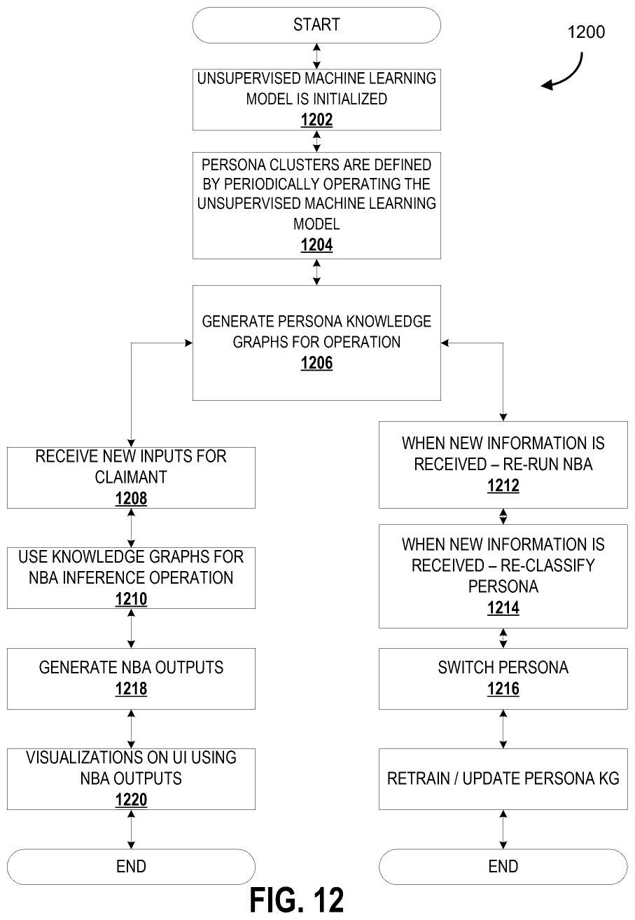

FIG. 12 is a process diagram 1200 showing steps of an example method for using persona-based knowledge graphs, according to some embodiments.

At 1202, an unsupervised machine learning model is initialized that is then iteratively trained to establish one or more clusters, each of the clusters representing a potential “persona” to aid in domain-specific learning by the downstream next best action model. In some embodiments, the number of clusters can be fixed based on a target pre-defined number of clusters, and can be optimized based on a loss function that can use various metrics as proxies for complexity and difficulty of treatment, such as cost of treatment, or recovery time, or a balanced function of both.

Training data from a corpus of historical treatments are utilized to define these clusters, and essentially the data points corresponding to different patient journeys are used to define different clustered groups of individuals based on their similarities. The patient journeys from the training set, based on patient identifiers, for example, can be assigned a cluster number (e.g., persona 1-500). Unsupervised learning is useful because it can be used to automatically identify bifurcation points that impact the length of recovery and the cost of treatment (e.g., for two sub-types of disease, while related, they may have very different prognosis and available treatments).

The number of the clusters/personas can be based on available computing power and processing time. This allows a level of tuning for accuracy based on the finite considerations of available computing resources. If there is sufficient computing power and an extremely large number of possible personas are possible to be maintained in memory, the personas can instead be based on very subtle differences in treatment and prognosis that can are not based on human identified bifurcations, but rather utilize the power of unsupervised machine learning to automatically generate different cluster/classifications. On the other hand, if there is limited computing power, the number of personas can be constrained intentionally to conserve the limited computing power and processing resources.

At 1204, the clusters are defined by periodically operating the unsupervised machine learning model as a classification machine learning model to re-generate or update persona classifications, clusters, and each persona knowledge graph. This re-training can be conducted so that the system is able to automatically adjust to or handle changes in treatment outcomes, recommended treatment pathways, among others, without explicit programming. For example, a new gene therapy treatment may become available for a particular hereditary disease with vastly improved treatment outcomes, with a new treatment cost and duration. As patients are shifted to these treatments, their records will reflect these treatments and their associated costs, durations, success rates, impacts on downstream activities, etc., and these can be automatically adjusted for through re-training or re-generation of the knowledge graphs from time to time. The re-training can include an intentional recency bias to add additional training weight to more recent training examples to further encourage the automatic updating.

At 1206, after training, the identified clustering and the trained unsupervised machine learning model operating as a classification machine learning model can be deployed for use. For each cluster corresponding to each persona, a knowledge graph is generated based on the characteristics of the population-level group of patient journeys in the historical set that have been classified for that particular cluster/persona. The knowledge graph is a directed graph with different nodes representing different transitions within the journey, and the training is used to identify weighted interconnections, as well as how each characteristic leads to a particular next step. Accordingly, the generated knowledge graph provides domain-specific knowledge trained from the corpus of clustered data points, and can be used for future inference. The generation of the persona specific knowledge graphs can be computationally expensive, but once generated, the persona specific knowledge graphs can reduce future computational load as it can be updated only sporadically, front-loading computational effort during this training stage.

At 1208, during inference operation, when a new individual's data is being ingested into the system, for example, in the form of input datasets extracted from doctor's notes, hospital APIs, insurance records, etc., the classification machine learning model is used to first classify and categorize the individual in respect of highest similarity to a specific generated persona cluster. Named entity recognition engines can be used to pre-process ingested data to assist in improving the accuracy of the classifications and datasets during inference operation. At the end of this step, the new individual's data is now associated with a particular persona of the available sets of personas, and the corresponding trained knowledge graph can be retrieved from data storage.

At 1210, the corresponding trained knowledge graph can then be used to generate a set of logit/probability outputs based on a potential identified next course of treatment for the individual. This process can also be used iteratively to build out second order treatment, third order treatment, among others, and an output data structure indicative of the individual's next action, second next action following each of the potential first next actions, etc., can be populated. This data structure can include logit probabilities for each, and ultimately be used to generate a tree of potential outcomes and treatment paths for the individual that is personalized based on a combination of the categorized knowledge graph, as well as the individual's characteristics.

A benefit of using the knowledge graph and the individual's characteristics is that the persona-specific knowledge graph imparts domain-specific knowledge to the machine learning, automatically improving accuracy by allowing the system to access this knowledge for more accurate, up to date, and contextualized responses by grounding the model's output in the knowledge base, reducing the risk of hallucinations, and imparting subtle differences in treatment and care for an individual based on historically similar patient journeys.

At 1212, as new information and datasets become available in respect of a particular individual, the machine learning model for identifying the next course of treatment can be re-run based on the updated information to identify changes to the output data structure that need to be updated. In some embodiments, as new information and datasets become available, the persona classification machine learning model may also be re-run to re-classify the user (e.g., automatically shifting selected persona knowledge graphs to a more similar knowledge graph). For example, the user may first present with arm pain from an accident and a bone appears to be broken. Then, the user may input details of the accident (e.g., fell from tree) that are captured during intake.

At 1214, as the user provides more details or testing results become available through radiology, electronic health records, among others, an improved dataset of the user's condition is now available. This can include co-morbidity information or characteristics (osteoarthritis, diabetes, age, severe hypertension, infection, sepsis) that will have impacts on whether treatment will be successful, as well as a potential duration of recovery and required rehabilitation. Similarly, additional information may include radiology outputs that are captured such as whether the user has an open fracture, a compound fracture, a stick fracture, etc. The user's condition can also be represented in the form of a knowledge graph data structure, alongside the user's individual characteristics. Both of these can be generated from extracted outputs from the user's health record as it is being populated and updated, for example. The benefit of generating a knowledge graph for the user is that it becomes easier to classify the user's graph to a specific cluster/persona as the same engine can be operated for classification.

At 1216, as the new information is captured, the classification model can be operated in an inference mode to determine whether the user needs to be classified in respect of a different persona. When the next best action model is operated on inference to establish generated set of logit/probability outputs, it can thus attempt to utilize the knowledge graph as an input of the most similar persona. A technical benefit of using only a limited number of possible persona clusters is that it allows the computation to be operated with a practically manageable amount of computational power, as every iteration of updates and training can be computationally expensive in view of finite computing processing resource and time. In a preferred embodiment, the next best action machine learning model is operated using a combination of three data structures, (1) a knowledge graph data structure corresponding to the persona cluster, (2) a knowledge graph data structure populated based on the claimant's journey so far, and (3) a set of characteristics of the claimant as extracted from various documents associated with the claimant, such as the claimant's electronic health record.

At 1218, the output data structure generated by the next best action machine learning model operating in inference, once fully populated, is used for various practical downstream uses. Example downstream uses include automatically recommending or requisitioning courses of treatment for an individual, or generating probabilistic treatment plans or identifying a predicted total treatment cost, which can then be used from an insurance perspective to right-size an allocation based on a complexity level associated with a particular individual's characteristics, presented injury, as well as the specific trained knowledge graph for a particular persona.

An example output can include the next possible steps of treatment include option A, option B, and option C based on what is being presented for the claimant thus far in the journey. In this example, option A could be a surgical intervention followed by rehabilitation, option B could be a non-surgical intervention followed by rehabilitation, and option C could be rehabilitation only. These can be generated by querying the next best action engine, and each option can be associated with an adjusted probability of success, an overall treatment cost, and an expected duration of recovery, all generated by the next best action engine operating in inference mode.

As the selection of a particular option may lead to downstream options, and so forth, in some embodiments, the next best action engine is also queried for potential downstream options, and the output data structure is generated using the outputs from the next best action engine in aggregate, multiplying downstream options and activities all the way until resolution by associated probabilities of selection, based primarily on the persona based cluster knowledge graph traversal for example, with the next best action engine using the various available data structures to more accurately assess, for this specific user, what the estimated prognosis, cost, duration of recovery, are given the user's specific characteristics (e.g., high blood pressure, early stages of osteoarthritis, diabetes complications).

At 1220, the output data structure is provided across a programming interface to a visualization engine to control the rendering of visual interface elements on a coupled user interface, such as a user interface on a user or a claim advisor's personalized computing device, such as a personal computer, a terminal, or a smartphone. These visual interface elements can include a probabilistic map of the user's treatment, along with expected costs, duration, and a probability of successful treatment for different treatment options, as well as second and third-level analyses depending on different treatment paths.

Such a specialized interface that is customized for a particular claimant's journey helps an advisor provide more accurate estimations or guidance to the claimant, providing a more realistic perspective on potential outcomes to allow the claimant to make informed decisions. For example, if the claimant is in a particularly vulnerable demographic with identified characteristics, a surgical intervention may not always be superior to a non-surgical intervention. The benefit of using both the claimant's knowledge graph and the persona-based knowledge graph in combination is that the next best action engine is thus configured to utilize a combination of domain specific and domain general knowledge for processing. Finally, as noted earlier, the persona-based knowledge graph approach can also be fine tuned based on available computing resources, and because the training and generation of the persona-based knowledge graph can operate asynchronously, it can also help offload and adjust computing load (e.g., the persona-based knowledge graphs can be generated or updated only during off-peak hours and not in real-time, while the inference operation can occur in real-time or near-real time).

As the user's information and journey has also been classified for a particular persona/cluster, as the user undergoes treatment, the outcomes and treatment plans can be recorded and used to periodically re-train the knowledge graph for that particular cluster. Depending on how clusters are modified over time due to re-training and knowledge graph updates, in some embodiments, the system is configured to periodically re-generate clusters based on triggered characteristics of the corpus of clusters.

For example, if a centroid representing each cluster is starting to move together or move too far apart, the centroid movement can be used to determine when a cluster should be bifurcated to spawn a new cluster or two clusters should be combined. In some embodiments, instead of specific bifurcations or combinations, instead, when the overall cluster centroids have become too close together or too far based on overall relations between the aggregate of cluster centroids, the entire system is triggered to simply regenerate clusters, and regenerate corresponding persona knowledge graphs.

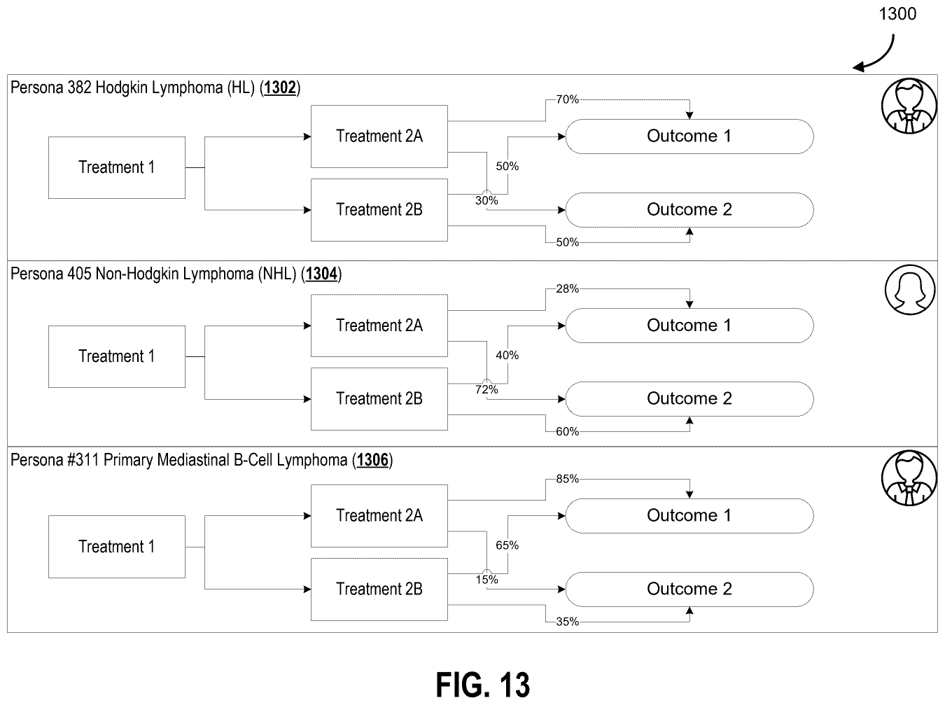

FIG. 13 is an example set of knowledge graphs 1300 for different personas, according to some embodiments.

1302 is an example knowledge graph for Hodgkin Lymphoma (HL). 1304 is an example knowledge graph for Non-Hodgkin Lymphoma (NHL). 1306 is an example knowledge graph for a rarer form of lymphoma, Primary Mediastinal B-Cell Lymphoma. The three knowledge graphs are shown as non-limiting examples, and are simplified examples.

In practical implementation, there is a much higher level of sophistication and automation, and potential subtleties between personas (as opposed to this example where the split is based on types of lymphomas). For example, if there is sufficient computing power and an extremely large number of possible personas are possible to be maintained in memory, the personas can instead be based on very subtle differences in treatment and prognosis that can are not based on human identified bifurcations, but rather utilize the power of unsupervised machine learning to automatically generate different cluster/classifications.

Once the clusters are identified, patient journeys are assigned different cluster numbers by the engine. For example, out of one million patient journey, there may be 451 in persona 1, 102 in persona 2, 14 in persona 3, and so on. In this example, out of one million patient journey, there are 25 cases under the persona for Hodgkin Lymphoma (HL), 1302, 185 under the persona for Non-Hodgkin Lymphoma (NHL), and 3 under the persona for Primary Mediastinal B-Cell Lymphoma. The corresponding patient journeys are extracted from a database of electronic health records. Then the journeys are vectorized and used to identify specific treatment steps, their associated costs, the success rate of treatment, and to generate a set of probabilities and potential bifurcations (e.g., success/failure) as between the individual patient journeys, and these can be associated with specific comorbidities or other types of personal characteristics (e.g., age, gender, white blood cell count, ejection fraction) if available.

During inference, the knowledge graph data structures are provided to the next best action engine during machine learning to improve the accuracy of the machine learning.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

What is claimed is:

1. A computer system for using a specifically trained machine learning model to generate a next best action for an insurance claim based on a plurality of reference knowledge graph structures used for unsupervised characterization of dynamic claimant knowledge graph structures, the system comprising:
at least one processor;
at least one memory device coupled to the processor;
wherein the memory device comprises instructions which when executed by the processor cause the computer system to:
generate the plurality of reference knowledge graph structures, each having:
a plurality of information nodes based on an initial set of data objects and an initial set of edges based on relationships between the initial set of data objects, each data object within the initial set of data objects corresponding to at least one of an initial text string and an initial context identifier, the initial text string based on at least one of demographic or medical data, and the initial context identifier identifies at least one of a temporal context, a treatment context, a treatment outcome context, and a stage of treatment context; and
a plurality of treatment and treatment outcome nodes arranged temporally, representing next best actions and expected outcomes, where each treatment node is connected by an edge to the one or more information nodes and to a treatment outcome;
store the plurality of reference knowledge graphs within a memory of the machine learning model;
receive at a network gateway one or more digital copies of structured and unstructured documents corresponding to one or more claimants;
extract, through a named entity recognition engine, data objects corresponding to a claimant from the one or more digital copies of structured and unstructured documents based on the initial text strings within the plurality of reference knowledge graph structures;
generate, through the machine learning model, a claimant knowledge graph structure associated with the claimant by populating nodes using the extracted data objects, and generating edges within the claimant knowledge graph structure using the initial set of edges stored within the machine learning model, the nodes of the claimant knowledge graph structure having a text string corresponding to one of the initial text strings and at least a document identifier for identifying the document which contained the extracted data object, a timestamp and a context identifier corresponding to one of the initial context identifiers;
search, using the machine learning model, the one or more reference knowledge graphs for portions of the nodes and edges which have a full or partial match with the nodes and edges within the claimant knowledge graph;
identify a claimant profile based on the one or more reference knowledge graphs which have a full or partial match with the claimant knowledge graph; and
generate and transmit to a user interface an output, using a next best action engine, comprising at least one next best action for the claimant based on the claimant profile, the at least one next best action generated by extracting the one or more treatment nodes within the subset of reference knowledge graphs which are associated with the claimant profile.

2. The system of claim 1, wherein the claimant knowledge graph is updated with one or more new nodes and edges corresponding to an actual outcome of a next best action, and the large language model is configured for global assessment of the actual outcome of a next best action for the plurality of claimants compared to an expected outcome represented by a treatment outcome node within the reference knowledge graph associated with the next best action, and the large language model adds to or removes a subset of the nodes and edges within the reference knowledge graph structure based on the comparison of the actual outcomes and the expected outcomes to augment the next best action engine and named entity recognition engine.

3. The system of claim 1, wherein the machine learning model identifies a divergence between the expected treatment outcome node in a reference knowledge graph and an actual treatment outcome node in the claimant's knowledge graph, and maps claimant knowledge graphs into divergent clusters associated with shared divergence patterns, the cluster of divergent knowledge graphs are searched for nodes or edges within the divergent cluster of claimant knowledge graphs which are not shared with the reference knowledge graph associated with the expected treatment outcome.

4. The system of claim 3, wherein the machine learning model generates one or more new reference knowledge graphs by bifurcating the reference knowledge graph associated with the expected treatment outcome to include the nodes, edges and actual treatment outcome node present within the divergent cluster of knowledge graphs.

5. The system of claim 1, wherein the next best action engine is further configured to generate the at least one next best action with a corresponding confidence score which is associated with a percentile representation of the partial or full match between the claimant knowledge graph and the reference knowledge graph associated with the next best action.

6. The system of claim 1, wherein the digital copies of structured and unstructured documents are translated into English text strings using a translation server having a specifically built library containing context dependent translation rules for medical and health adjacent text strings.

7. The system of claim 1, wherein the machine learning model searches for patterns of nodes and edges present in historical knowledge graphs of the plurality of claimants and generates new reference knowledge graph structures based on novel patterns of nodes and edges which are not present within existing reference knowledge graph structures.

8. The system of claim 1, wherein the initial set of data objects and initial set of edges are transmitted to the machine learning model through prompting and are based on historical treatment data and outcomes.

9. The system of claim 1, wherein the digital copies of structured and unstructured documents are tokenized into a series of text strings associated with an original copy of the structured or unstructured document, the series of text strings containing metadata including the timestamp and document identifier, the name entity recognition engine parses the tokenized text strings to extract the data objects for generating the claimant knowledge graphs.

10. The system of claim 1, wherein the processor and memory device are stored within a secure on-premises server to restrict access to data objects associated with the claimants.

11. A computer implemented method for using a specifically trained machine learning model to generate a next best action for an insurance claim based on a plurality of reference knowledge graph structures used for unsupervised characterization of dynamic claimant knowledge graph structures, the computer method comprising:
generating the plurality of reference knowledge graph structures, each having a plurality of information nodes based on an initial set of data objects and an initial set of edges based on relationships between the initial set of data objects, each data object within the initial set of data objects corresponding to at least one of an initial text string and an initial context identifier, the initial text string based on at least one of demographic or medical data, and the initial context identifier identifies at least one of a temporal context, a treatment context, a treatment outcome context, and a stage of treatment context; and
a plurality of treatment and treatment outcome nodes arranged temporally, representing next best actions and expected outcomes, where each treatment node is connected by an edge to the one or more information nodes and to a treatment outcome;
storing the plurality of reference knowledge graphs within a memory of the machine learning model;
receiving at a network gateway one or more digital copies of structured and unstructured documents corresponding to one or more claimants;
extracting, through a named entity recognition engine, data objects corresponding to a claimant from the one or more digital copies of structured and unstructured documents based on the initial text strings within the plurality of reference knowledge graph structures;
generating, through the machine learning model, a claimant knowledge graph structure associated with the claimant by populating nodes using the extracted data objects, and generating edges within the claimant knowledge graph structure using the initial set of edges stored within the machine learning model, the nodes of the claimant knowledge graph structure having a text string corresponding to one of the initial text strings and at least a document identifier for identifying the document which contained the extracted data object, a timestamp and a context identifier corresponding to one of the initial context identifiers;
searching, using the machine learning model, the one or more reference knowledge graphs for portions of the nodes and edges which have a full or partial match with the nodes and edges within the claimant knowledge graph;
identifying a claimant profile based on the one or more reference knowledge graphs which have a full or partial match with the claimant knowledge graph; and
generating and transmitting to a user interface an output, using a next best action engine, comprising at least one next best action for the claimant based on the claimant profile, the at least one next best action generated by extracting the one or more treatment nodes within the subset of reference knowledge graphs which are associated with the claimant profile.

12. The method of claim 11, wherein the claimant knowledge graph is updated with one or more new nodes and edges corresponding to an actual outcome of a next best action, and the large language model is configured for global assessment of the actual outcome of a next best action for the plurality of claimants compared to an expected outcome represented by a treatment outcome node within the reference knowledge graph associated with the next best action, and the large language model adds to or removes a subset of the nodes and edges within the reference knowledge graph structure based on the comparison of the actual outcomes and the expected outcomes to augment the next best action engine and named entity recognition engine.

13. The method of claim 11, wherein the machine learning model identifies a divergence between the expected treatment outcome node in a reference knowledge graph and an actual treatment outcome node in the claimant's knowledge graph, and maps claimant knowledge graphs into divergent clusters associated with shared divergence patterns, the cluster of divergent knowledge graphs are searched for nodes or edges within the divergent cluster of claimant knowledge graphs which are not shared with the reference knowledge graph associated with the expected treatment outcome.

14. The method of claim 13, wherein the machine learning model generates one or more new reference knowledge graphs by bifurcating the reference knowledge graph associated with the expected treatment outcome to include the nodes, edges and actual treatment outcome node present within the divergent cluster of knowledge graphs.

15. The method of claim 11, wherein the next best action engine is further configured to generate the at least one next best action with a corresponding confidence score which is associated with a percentile representation of the partial or full match between the claimant knowledge graph and the reference knowledge graph associated with the next best action.

16. The method of claim 11, wherein the digital copies of structured and unstructured documents are translated into English text strings using a translation server having a specifically built library containing context dependent translation rules for medical and health adjacent text strings.

17. The method of claim 11, wherein the machine learning model searches for patterns of nodes and edges present in historical knowledge graphs of the plurality of claimants and generates new reference knowledge graph structures based on novel patterns of nodes and edges which are not present within existing reference knowledge graph structures.

18. The method of claim 11, wherein the initial set of data objects and initial set of edges are transmitted to the machine learning model through prompting and are based on historical treatment data and outcomes.

19. The method of claim 11, wherein the digital copies of structured and unstructured documents are tokenized into a series of text strings associated with an original copy of the structured or unstructured document, the series of text strings containing metadata including the timestamp and document identifier, the name entity recognition engine parses the tokenized text strings to extract the data objects for generating the claimant knowledge graphs.

20. A non-transitory computer readable medium storing machine interpretable instructions which when executed by a processor, cause the processor to perform a computer implemented method for using a specifically trained machine learning model to generate a next best action for an insurance claim based on a plurality of reference knowledge graph structures used for unsupervised characterization of dynamic claimant knowledge graph structures, the method comprising:
generating the plurality of reference knowledge graph structures, each having a plurality of information nodes based on an initial set of data objects and an initial set of edges based on relationships between the initial set of data objects, each data object within the initial set of data objects corresponding to at least one of an initial text string and an initial context identifier, the initial text string based on at least one of demographic or medical data, and the initial context identifier identifies at least one of a temporal context, a treatment context, a treatment outcome context, and a stage of treatment context; and
a plurality of treatment and treatment outcome nodes arranged temporally, representing next best actions and expected outcomes, where each treatment node is connected by an edge to the one or more information nodes and to a treatment outcome;
storing the plurality of reference knowledge graphs within a memory of the machine learning model;
receiving at a network gateway one or more digital copies of structured and unstructured documents corresponding to one or more claimants;
extracting, through a named entity recognition engine, data objects corresponding to a claimant from the one or more digital copies of structured and unstructured documents based on the initial text strings within the plurality of reference knowledge graph structures;
generating, through the machine learning model, a claimant knowledge graph structure associated with the claimant by populating nodes using the extracted data objects, and generating edges within the claimant knowledge graph structure using the initial set of edges stored within the machine learning model, the nodes of the claimant knowledge graph structure having a text string corresponding to one of the initial text strings and at least a document identifier for identifying the document which contained the extracted data object, a timestamp and a context identifier corresponding to one of the initial context identifiers;
searching, using the machine learning model, the one or more reference knowledge graphs for portions of the nodes and edges which have a full or partial match with the nodes and edges within the claimant knowledge graph;
identifying a claimant profile based on the one or more reference knowledge graphs which have a full or partial match with the claimant knowledge graph; and
generating and transmitting to a user interface an output, using a next best action engine, comprising at least one next best action for the claimant based on the claimant profile, the at least one next best action generated by extracting the one or more treatment nodes within the subset of reference knowledge graphs which are associated with the claimant profile.
